(19) United States
(12) Patent Application Publication
(10) Pub. No.: US 2010/0272920 A1
(43) Pub. Date: Oct. 28, 2010

(54) Radiation Curable System

(75) Inventor: John Lyndon Garnett, Neutral Bay (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: John Lyndon GARNETT, Neutral Bay (AU)

(21) Appl. No.: 12/161,528

(22) PCT Filed: Jan. 12, 2007
(86) PCT No.: PCT/AU2007/000025

§ 371 Date: Sep. 22, 2008

(30) Foreign Application Priority Data
Jan. 12, 2006 (AU) 2006900144
Oct. 20, 2006 (AU) 2006905848

(51) Int. Cl. B05D 3/06; B05D 1/18; B05D 5/00; C08G 79/02; C08L 85/02

(52) U.S. Cl. 427/551; 427/532; 427/430.1; 427/160; 528/398; 528/399; 524/610

(57) ABSTRACT

The present invention relates to a process for producing a composite material. A radiation-curable water-compatible composition is applied to the surface of a substrate having a high water content, wherein the composition comprises at least one radiation-polymerisable monomer and/or oligomer, whereby the composition wets the surface of the substrate. The composition on the substrate is then irradiated to produce the composite material. Optionally the monomer and/or oligomer is reacted with a phosphite or a triorganophosphine prior to the irradiation. These compositions may also be applied to low water content substrates.

### TECHNICAL FIELD

The present invention relates to a radiation curable system, in particular to the curing of monomer/oligomer/polymer mixtures by ultraviolet light (UV) or ionising radiation.

### BACKGROUND OF THE INVENTION

Ionising radiation includes machine sources such as electron beam (EB), X-ray or elemental sources like cobalt 60, which generates gamma rays, strontium 90 or cesium 137 and the like. UV curing commonly uses photoinitiators to initiate fast reaction. The monomer/oligomer/polymer systems predominantly used in such processes are acrylates with approximately ten percent of the market involving epoxies for cationic UV curing.

A problem with these formulations is that they are generally not compatible with water and therefore handling of the coating made from these materials on line necessitates the use of solvents. This situation is to be avoided if possible because solvents are environmentally unfriendly. This difficulty is particularly relevant to washing up procedures where relatively large volumes of solvent are usually required to clean the facility.

The problem with using currently known water based materials is that they require the use of such large volumes of water in radiation curable formulations which are based on these aqueous dispersions. In addition, the chemistry available for the designs of these oligomers is also restricted usually to specialised urethanes. This in turn necessitates the use of ovens to remove the water in the coating on-line prior to exposure to UV or ionising radiation sources to achieve ultimate cure.

The requirements of additional facilities such as oven on-line defeats one of the main purposes and advantages of using radiation curing, namely the conserving of electrical energy and the saving in plant space on the factory floor.

### OBJECT OF THE INVENTION

It is the object of the present invention to substantially overcome or at least ameliorate one or more of the above disadvantages.

### SUMMARY OF THE INVENTION

The present inventor has realised that because oligomer water dispersions currently known are relatively low in solids (usually 40-50%) they require large volumes of water in radiation curable formulations.

In a first aspect of the invention there is provided a process for producing a composite material comprising:
applying a radiation-curable water-compatible composition to a hydrophilic surface of a substrate, said composition comprising at least one radiation-polymerisable species selected from the group consisting of monomers and oligomers and mixtures of monomers and oligomers, whereby the composition wets the surface of the substrate; and
irradiating the composition on the substrate to cure the composition and thereby produce the composite material, said composite material comprising the cured composition on the substrate.

The composition may be a radiation-curable water-compatible composition which is radiation curable without the necessity to reduce the water content of the composition prior to curing. The composition may have a solids content of at least about 55% w/w, w/v or v/v. The composition may have a solids content of at least about 60% w/w, w/v or v/v.

Thus a process for producing a composite material comprises:
applying a radiation-curable water-compatible composition to a hydrophilic surface of a substrate, said composition comprising at least one radiation-polymerisable species selected from the group consisting of monomers and oligomers and mixtures of monomers and oligomers, whereby the composition wets the surface of the substrate, said composition being radiation curable without the necessity to reduce the water content of the composition prior to curing; and
irradiating the composition on the substrate to cure the composition and thereby produce the composite material, said composite material comprising the cured composition on the substrate.

The substrate may be a wet substrate. In this context, “wet” may be taken to refer to a water content above the equilibrium water content at room temperature and 65% relative humidity (RH). The surface of the substrate may be wet. It may be wet with an aqueous liquid or a water miscible liquid, e.g. an aqueous solution. The surface may or may not have discrete water or other aqueous liquid thereon. The surface may have a high water content. In this context the surface may be considered to be the top 1 micron of the substrate, or the top 2 microns, or the top 3 microns, or the top 4 microns, or the top 5 microns or the top 10 microns of the substrate. The process may comprise the step of allowing the composition to penetrate the surface of the substrate, or to penetrate throughout the substrate, prior to irradiating. The process may comprise the step of allowing the composition to cure within the substrate during and/or after the irradiating. This may comprise allowing sufficient time for the composition to cure within the substrate. The sufficient time may be for example about 1 day, or may be about 2 days. The irradiating may be from one side of the substrate (e.g. the upper or top side thereof, or the lower or bottom side thereof) or from both sides of the substrate. If the irradiating is from both sides of the substrate, a first side may be irradiated simultaneously or non-simultaneously with a second side.

In an embodiment of the first aspect, the process comprises:
applying a radiation-curable water-compatible composition to a surface of a substrate having a high water content, said composition comprising at least one radiation-polymerisable species selected from the group consisting of monomers and oligomers and mixtures of monomers and oligomers, whereby the composition wets the surface of the substrate; and
irradiating the composition on the substrate to cure the composition and thereby produce the composite material, said composite material comprising the cured composition on the substrate.

The composition may be a radiation-curable water-compatible composition which is radiation curable without the necessity to reduce the water content of the composition prior to curing.

In another embodiment of the first aspect, the process comprises:
applying a radiation-curable water-compatible composition to a wet surface of a substrate, said composition comprising at least one radiation-polymerisable species selected from the group consisting of monomers and oligomers and mixtures of monomers and oligomers, whereby the composition wets the surface of the substrate; and
irradiating the composition on the substrate to cure the composition and thereby produce the composite material, said composite material comprising the cured composition on the substrate and optionally also in the substrate.

The composition may be a radiation-curable water-compatible composition which is radiation curable without the necessity to reduce the water content of the composition prior to curing.

The composition used in the first aspect may be UV-curable. It may be e-beam-curable. It may be X-ray curable. It may be curable by two or more of UV, e-beam and X-ray. The composition may be gamma ray-curable. The step of irradiating may comprise exposing the composition to UV radiation, gamma ray radiation, e-beam radiation or X-ray radiation for sufficient time and at sufficient intensity to cure the composition. The cure may be rapid, and may require irradiation for less than about 60 seconds of irradiating, or for one of the following time ranges: less than about 30, less than about 10 or less than about 5 seconds.

In some embodiments the composition does not contain a photoinitiator. It may contain no photoinitiator that is not a monomer or oligomer which polymerises during the step of irradiation. One or more of the monomers and/or oligomers may function as a photoinitiator.

The composition may have a solids content of at least about 70% w/w, w/v or v/v.

The composition may wet the substrate. It may have a contact angle with the substrate of less than about 100.

The composition may be an aqueous composition. It may comprise at least one radiation-polymerisable water-compatible oligomer. It may comprise at least one radiation-polymerisable water-soluble oligomer. The radiation-polymerisable water-compatible oligomer may be water soluble, or dispersible in water. The composition my additionally comprise at least one radiation-polymerisable oligomer that is not water-compatible. The composition may comprise at least one photoinitiator. The composition may comprise at least one water-compatible photoinitiator. The composition may comprise at least one water-soluble photoinitiator. The composition may comprise a reaction product of a radiation-curable water-compatible oligomer with a triorganophosphite or triorganophosphine, for example with triphenyl phosphite or triphenylphosphine. The composition may comprise one or more (e.g. 2, 3, 4, 5 or more than 5) monomers which are radiation polymerisable. The monomers may be vinyl monomers (e.g. acrylates, methacrylates), or may be reaction products thereof with a triorganophosphite or with a triorganophosphine. They may comprise charge-transfer complexes. The composition may comprise one or more crosslinkers. The, or each, crosslinker may be a monomer or an oligomer having at least 2 polymerisable groups (e.g. 3, 4, 5 or more than 5 polymerisable groups). The polymerisable groups may be carbon-carbon double bonds. Suitable crosslinkers include ethylene glycol dimethacrylate or diacrylate, polyethylene glycol dimethacrylate or diacrylate, trimethylol methane triacrylate or trimethacrylate, acrylated or methacrylated pentaerythritol, etc. The crosslinker may be a reaction product of a triorganophosphite. It may be a reaction product of a triorganophosphine with a crosslinker as described above.

The composition may comprise a non-aqueous solvent. The non-aqueous solvent, if present, may be water compatible. It may be water miscible. It may be present in up to about 10% by weight or volume or weight per volume of the composition, or in any one of the following concentrations: up to about 9%, up to about 8%, up to about 7%, up to about 6%, or up to about 5% of the composition. It may be present in any one of the following concentration ranges: between about 0 and 10, 1 and 10, 2 and 10, 5 and 10, 0.1 and 5, 1 and 5, 0.1 and 2, 1 and 2, 2 and 5 or 3 and 8%, e.g. in any one of the following concentrations: about 0.1, 0.5, 1, 1.5, 2, 2.5, 3, 3.5, 4, 4.5, 5, 6, 7, 8, 9 or 10%. The percentage may be by weight or by volume or weight per volume. Suitable solvents include alcohols (e.g. ethanol, methanol, isopropanol) ketones (e.g. acetone, butanone, methyl isobutyl ketone etc.) etc. These may serve to solubilise one or more components of the composition, and may also serve to adjust the viscosity of the composition.

The step of irradiating results in polymerisation and/or copolymerisation of some or all of the components of the composition. The polymerisation may be a free radical or addition polymerisation. The polymerisation may comprise crosslinking.

The radiation-curable water-compatible oligomer may be an amine salt prepolymer. The amine salt prepolymer may be a reaction product of an unsaturated carboxylic acid and an oligomer having at least one amine group, said oligomer being selected from the group consisting of urea-formaldehyde resins, melamine-formaldehyde resins, amine-polyisocyanate adducts, Michael adducts of a secondary amine with one or more acrylate compounds, Michael adducts of a secondary amine with one or more methacrylate compounds, and epoxy-amine adducts.

The composition may additionally comprise one or more polymerisable species selected from the group consisting of aromatic urethane acrylates, aliphatic urethane acrylates, polyester acrylates, epoxy acrylates, thiol-ene resins and polymerisable charge transfer complexes.

As noted earlier, the composition may comprise one or more monomers. The one or more monomers may be water-compatible. The one or more monomers may be water-soluble. These may be any suitable monomers that are polymerisable using e-beam, gamma ray, X-ray or UV (or more than one of these). They may be acrylates or other olefinic monomers. They may comprise one polymerisable group, or more than one (e.g 2, 3, 4 or 5 polymerisable groups), i.e. they may be monofunctional, bifunctional or polyfunctional.

If the composition is e-beam-curable or X-ray-curable, the step of irradiating may use an e-beam or X-ray of less than about 2Mrad.

The substrate may have a water content of at least about 20% by weight. It may be selected from the group consisting of a sheet of material derived from the trunk of a banana plant, medium density fibreboard, particle board, timber veneer, paper, fibre cement board, other cement board, board made from compressed wheat, and animal hide. In some embodiments the substrate is a thin substrate, e.g. less than any one of the following thicknesses: about 0.6, 0.5, 0.4, 0.3 or 0.2 mm thick, or a thickness in the range of any one of the following thickness ranges: between about 0.1 and about 0.6, about 0.1 and about 0.5, about 0.1 and about 0.4 or about 0.1 and about 0.3 or about 0.2 and about 0.5 mm thick or about 0.15 and about 0.4 mm thick, or about 0.15 and about 0.3 mm thick, or about 0.15 and about 0.25 mm thick, or about 0.2 and about 0.4 mm thick, or about 0.2 and about 0.3 mm thick, or about 0.2 and about 0.25 mm thick. The substrate may be a veneer or a laminate. It may be flexible. It may be unwarped. The substrate may be partially dried prior to the step of irradiating. The partial drying may for example comprise passing the substrate between rollers under pressure, in order to physically squeeze water or aqueous liquid from the substrate.

The process may additionally comprise the step of at least partially drying the composite material. The drying may comprise heating the composite material and/or applying a partial vacuum to the composite material and/or passing a stream of gas (optionally dry gas), e.g. air, over or past the composite material.

The process may produce a composite material comprising an organic polymer (cured resin) in a location selected from on the substrate, in the substrate and both in and on the substrate. The polymer may be on one or both sides of the substrate. The polymer may be on the surface of the substrate. The polymer may be on the front surface of the substrate. The polymer may be on the back surface of the substrate. The polymer may be on the back and front surfaces of the substrate.

In another embodiment of the invention:
the radiation-curable water-compatible composition comprises a UV-curable, gamma ray-curable, e-beam-curable or X-ray-curable reaction product of a water-compatible oligomer with triphenyl phosphite, and has a solids content of between about 70 and 95% by weight;
the substrate comprises a sheet of material derived from the trunk of a banana plant having a water content of between about 20 and about 97% by weight; and
the step of irradiating comprises exposing the composition to UV radiation, gamma ray is radiation, e-beam radiation or X-ray radiation (or a combination of two or more of these either sequentially or simultaneously) for sufficient time and at sufficient intensity to cure the composition.

The composition may be a radiation-curable water-compatible composition which is radiation curable without the necessity to reduce the water content of the composition prior to curing.

In another embodiment the process comprises:
applying a radiation-curable water-compatible composition to a surface of a sheet of substrate having a content of at least about 20% by weight (optionally at least about 80 wt % or optionally between 20 and 97 wt %, or optionally between 80 and 97 wt %), said composition comprising a UV-curable, e-beam-curable or X-ray-curable reaction product of a water-compatible oligomer with triphenyl phosphite, and has a solids content of between about 70 and 95% by weight; and
irradiating the composition on the substrate to cure the substrate and thereby produce the composite material, said composite material comprising the cured composition on the substrate.

The composition may be a radiation-curable water-compatible composition which is radiation curable without the necessity to reduce the water content of the composition prior to curing.

In another embodiment the process comprises:
applying a radiation-curable water-compatible composition to a sheet of substrate having a content of at least about 20% by weight (optionally at least about 80 wt % or optionally between 20 and 97 wt %, or optionally between 80 and 97 wt %), said composition comprising a UV-curable, e-beam-curable or X-ray-curable reaction product of a water-compatible oligomer with triphenyl phosphite, and has a solids content of between about 70 and 95% by weight;
irradiating the composition on the substrate to cure the composition and thereby produce the composite material, said composite material comprising the cured composition on the substrate; and
drying the composite material.

The composition may be a radiation-curable water-compatible composition which is radiation curable without the necessity to reduce the water content of the composition prior to curing.

In another embodiment the process comprises:
at least partially drying a sheet of the substrate;
applying a radiation-curable water-compatible composition to the sheet of substrate having a content of at least 20% by weight (optionally at least about 80 wt % or optionally between 20 and 97 wt %, or optionally between 80 and 97 wt %), said composition comprising a UV-curable, e-beam-curable or X-ray-curable reaction product of a water-compatible oligomer with triphenyl phosphite, and has a solids content of between about 70 and 95% by weight; and
irradiating the composition on the substrate to cure the composition and thereby produce the composite material, said composite material comprising the cured composition on the substrate.

The composition may be a radiation-curable water-compatible composition which is radiation curable without the necessity to reduce the water content of the composition prior to curing.

In a second aspect of the invention there is provided a composite material when made by the process of the first aspect. The composite material may be flexible.

In a third aspect of the invention there is provided a radiation-curable water-compatible composition comprising a reaction product of a radiation-curable water-compatible oligomer with a triorganophosphite or with a triorganophosphine.

The composition may be a radiation-curable water-compatible composition which is radiation curable without the necessity to reduce the water content of the composition prior to curing. The composition may be any one or more of the following: UV-curable, gamma ray-curable, e-beam-curable or X-ray-curable. It may contain no photoinitiator. It may be curable by free-radical polymerisation or addition polymerisation. It may have a solids content of at least 55, 60 or 70% w/w, w/v or v/v. It may have a contact angle with a substrate having a high water content of less than about 10°. It may be aqueous. It may additionally comprise at least one radiation-polymerisable oligomer that is not water-compatible. The triorganophosphite may be triphenyl phosphite. The triorganophosphine may be triphenyl phosphine.

The radiation-curable water-compatible composition may be obtained by reaction of any one of a triorganophosphite or a triorganophosphine or both a triorganophosphite and a triorganophosphine with a water-curable water-compatible composition as described earlier, provided that the latter composition contains polymerisable olefinic groups.

The radiation-curable water-compatible oligomer may be an amine salt prepolymer. The amine salt prepolymer may be a reaction product of an unsaturated carboxylic acid and an oligomer having at least one amine group, said oligomer being selected from the group consisting of urea-formaldehyde resins, melamine-formaldehyde resins, amine-polyisocyanate adducts, Michael adducts of a secondary amine with one or more acrylate compounds, Michael adducts of a secondary amine with one or more methacrylate compounds, and epoxy-amine adducts and combinations of any two or more of these.

The composition may additionally comprises one or more polymerisable species selected from the group consisting of aromatic urethane (e.g. MDI, TDI) acrylates, aliphatic urethane acrylates, polyester acrylates, epoxy acrylates, thiol-ene resins and polymerisable charge transfer complexes.

As noted earlier, the composition may comprise one or more monomers. These may be any suitable monomers that are polymerisable or copolymerisable using e-beam, X-ray, gamma ray or UV (or more than one of these). They may be acrylates or other olefinic monomers. They may comprise one polymerisable group, or more than one (e.g. any one of the following numbers of polymerisable groups: 2, 3, 4 or 5), i.e. they may be monofunctional, bifunctional or polyfunctional.

The composition may be e-beam-curable or X-ray-curable using an e-beam of less than about 2Mrad or an X-ray beam of less than about 2Mrad. It may be curable on exposure to gamma radiation, for example, from cobalt 60.

In a fourth aspect of the invention there is provided a process for producing a composite material comprising:
applying a radiation-curable water-compatible composition to a substrate having a low water content, said composition comprising a reaction product of a radiation-curable water-compatible oligomer with a triorgano or a triorganophosphine; and
irradiating the composition on the substrate to produce the composite material.

The composition may be a radiation-curable water-compatible composition which is radiation curable without the necessity to reduce the water content of the composition prior to curing. The substrate may have a water content of less than about 20% by weight. It may be a dry substrate. In this context “dry” may be taken to mean “not wet”, wherein “wet” is as defined earlier. The substrate may be selected from the group consisting of a sheet of material derived from the trunk of a banana plant, medium density fibreboard, particle board, timber veneer, paper, polystyrene foam, fibre cement board, other cement board, board made from compressed wheat, and animal hide.

The composition may be a UV-curable composition and the step of irradiating may comprise exposing the composition to UV radiation for sufficient time and at sufficient intensity to cure the composition. It may be an e-beam-curable composition and the step of irradiating may comprise exposing the composition to e-beam radiation for sufficient time and at sufficient intensity to cure the composition. It may be an X-ray-curable composition and the step of irradiating may comprise exposing the composition to X-ray radiation for sufficient time and at sufficient intensity to cure the composition. In some embodiments the composition is curable by more than one of UV, gamma ray, e-beam and X-ray and the step of irradiation comprises exposing the composition to those wavelengths of radiation which are capable of curing it for sufficient time and at sufficient intensity is to cure the composition. The exposing to the different wavelengths may be simultaneous and/or sequential. Thus for example if the composition is UV curable and e-beam curable, the composition may be irradiated with a suitable UV wavelength for sufficient time to partially cure it, and with e-beam to complete the cure, or the composition may be irradiated with UV and e-beam simultaneously for suffient time to completely cure it, or it may be irradiated with UV for sufficient time to partially cure it and then with UV and e-beam simultaneously in order to complete the cure. It will be clear to one skilled in the art that other combinations are possible, and are envisaged by the present inventor.

The composition may comprise no photoinitiator. It may have a solids content of at least about 55, 60 or 70% w/w, w/v or v/v. It may have a contact angle with the substrate of less than about 100. It may be aqueous.

The composition may additionally comprise at least one radiation-polymerisable oligomer that is not water-compatible.

The composition may additionally comprise a water compatible stain. The composition may additionally comprise a water soluble stain.

The triorganophosphite may be triphenyl phosphite. The triorganophosphine may be triphenyl phosphine.

The radiation-curable water-compatible oligomer may be an amine salt prepolymer. The amine salt prepolymer may be a reaction product of an unsaturated carboxylic acid and an oligomer having at least one amine group, said oligomer being selected from the group consisting of urea-formaldehyde resins, melamine-formaldehyde resins, amine-polyisocyanate adducts, Michael adducts of a secondary amine with one or more acrylate compounds, Michael adducts of a secondary amine with one or more methacrylate compounds, and epoxy-amine adducts and combinations of any two or more of these.

The composition may additionally comprise one or more polymerisable species selected from the group consisting of aromatic urethane acrylates, aliphatic urethane acrylates, polyester acrylates, epoxy acrylates, thiol-ene resins and polymerisable charge transfer complexes and combinations of any two or more of these.

As noted earlier, the composition may comprise one or monomers. These may be any suitable monomers that are polymerisable using e-beam, X-ray or UV (or more than one of these). They may be acrylates or other olefinic monomers. They may comprise one polymerisable group, or more than one (e.g. any of the following numbers of polymerisable groups: 2, 3, 4 or 5), i.e. they may be monofunctional, bifunctional or polyfunctional.

The composition may be e-beam-curable or X-ray-curable. The step of irradiating may use is an e-beam of less than about 2Mrad or an X-ray of less than about 2Mrad.

The process may produce a composite material comprising an organic polymer in a location selected from on the substrate, in the substrate and both in and on the substrate.

The invention also provides a composite material when made by the process of the fourth aspect.

In a fifth aspect of the invention there is provided a method for preserving a solid substance comprising immersing said substance in a radiation-curable water-compatible composition comprising at least one radiation-polymerisable species selected from the group consisting of monomers and oligomers and mixtures of monomers and oligomers.

The substance may have a water content of greater than or equal to about 20% by weight. The composition may be UV-curable, gamma ray-curable, e-beam-curable or X-ray curable. It may be curable by more than one of UV, gamma ray, e-beam and X-ray. It may contain no photoinitiator. It may have a solids content of at least about 70% w/w, w/v or v/v. It may have a contact angle with the substance of less than about 10°. It may wet the substance. It may be aqueous. It may comprise a radiation-polymerisable water-compatible oligomer. The radiation-polymerisable water-compatible oligomer may be water soluble.

The composition may additionally comprise at least one radiation-polymerisable oligomer that is not water-compatible. It may comprise a reaction product of a radiation-curable water-compatible oligomer with a triorganophosphite e.g. with triphenyl phosphite. It may comprise a reaction product of a radiation-curable water-compatible oligomer with a triorganophosphine, e.g. with triphenyl phosphine. The radiation-curable water-compatible oligomer may be an amine salt prepolymer. The amine salt prepolymer may be a reaction product of an unsaturated carboxylic acid and an oligomer having at least one amine group, said oligomer being selected from the group consisting of urea-formaldehyde resins, melamine-formaldehyde resins, amine-polyisocyanate adducts, Michael adducts of a secondary amine with one or more acrylate compounds, Michael adducts of a secondary amine with one or more methacrylate compounds, and epoxy-amine adducts and combinations of any two or more of these.

The composition may additionally comprise one or more polymerisable species selected from the group consisting of aromatic urethane acrylates, aliphatic urethane acrylates, polyester acrylates, epoxy acrylates, thiol-ene resins and polymerisable charge transfer complexes and combinations of any two or more of these. These materials are well known in the art.

As noted earlier, the composition may comprise one or monomers. These may be any suitable monomers that are polymerisable using any one or more of the following: e-beam, X-ray, gamma ray or UV. They may be acrylates or other olefinic monomers. They may comprise one polymerisable group, or more than one (e.g. 2, 3, 4 or 5 polymerisable groups), i.e. they may be monofunctional, bifunctional or polyfunctional.

The substrate may be selected from the group consisting of a trunk of a banana plant, a portion thereof, a sheet of material derived therefrom, medium density fibreboard, particle board, timber veneer, paper, polystyrene foam, fibre cement board, other cement board, board made from compressed wheat, and animal hide.

In a sixth aspect of the invention there is provided a process for producing a composite material comprising:
immersing a substrate in a radiation-curable water-compatible composition comprising at least one radiation-polymerisable species selected from the group consisting of monomers and oligomers and mixtures of monomers and oligomers; and
irradiating the composition in a location selected from on the substrate, in the substrate and both in and on the substrate, to produce the composite material.

The composition may be a radiation-curable water-compatible composition which is radiation curable without the necessity to reduce the water content of the composition prior to curing. The process may additionally comprise the step of forming a sheet of the substrate prior to irradiating. The sheet of the substrate may be compressed between rollers in order to remove an aqueous liquid therefrom prior to irradiating. The process may comprise removing the substrate from the composition prior to the irradiating. It will be understood that this refers to removing the substrate from the bulk composition, whereby a proportion of the composition will remain in the removed substrate and/or on the surface thereof. If a sheet of the substrate is formed prior to irradiating, it may be formed prior to removal of the substrate from the composition.

In an embodiment of the sixth aspect:
the composition comprises a UV-curable, gamma ray-curable, e-beam-curable or X-ray curable reaction product of a water-compatible oligomer with triphenyl phosphite, and has a solids content of between about 55 and 98% by weight;
the substrate comprises the trunk of a banana plant or a portion thereof or is derived therefrom (e.g. is a sheet of material derived therefrom), and has a water content of between about 20 and about 97% by weight; and
the step of irradiating comprises exposing the composition to UV radiation, gamma radiation, e-beam or X-ray radiation for sufficient time and at sufficient intensity to cure the composition.

In another embodiment of the sixth aspect:
the composition comprises a UV-curable, gamma ray-curable, e-beam-curable or X-ray curable reaction product of a water-compatible oligomer with triphenyl phosphite, and has a solids content of between about 60 and 95% by weight;
the substrate comprises the trunk of a banana plant or a portion thereof or is derived therefrom (e.g. is a sheet of material derived therefrom), and has a water content of between about 25 and about 97% by weight; and
the step of irradiating comprises exposing the composition to UV radiation, gamma radiation, e-beam or X-ray radiation for sufficient time and at sufficient intensity to cure the composition.

The process may additionally comprise storing the substrate in the composition for between about one week and about 1 year prior to the step of irradiating.

The invention also provides a composite material made by the process of the sixth aspect. The process may additionally comprise the step of forming a sheet of the substrate prior to irradiating.

The invention also provides a laminated sheet comprising the above composite material adhered to a rigid planar backing material.

In a seventh aspect of the invention there is provided a process for making a laminated composite material comprising:
a) applying a first layer of a radiation-curable water-compatible composition to a substrate having a low water content, said composition comprising a reaction product of a radiation-curable water-compatible oligomer with a triorganophosphite or with a triorganophosphine;
b) applying a further substrate to the composition;
c) applying a top layer of the composition to the second substrate to form a precursor composite material; and
d) curing the composition to produce the laminated composite material.

The composition may be a radiation-curable water-compatible composition which is radiation curable without the necessity to reduce the water content of the composition prior to curing. The composition may also comprise an acrylic crosslinker.

Step d) may comprise:
irradiating the top layer of the composition with UV radiation so as to cure said top layer; and
heating the precursor composite material so as to cure the first layer of the composition.

Alternatively step d) may comprise irradiating the precursor composite material with e-beam or X-ray or gamma radiation (e.g. from a cobalt 60 source) of sufficient intensity to cure all layers of the composition.

Steps b) and c) may be repeated one or more times, e.g. the number of times may be any one of 2, 3, 4, 5, 6, 7, 8, 9 or 10 times to provide a multilayered composite material. In this case, step d) may be conducted between each repetition of steps b) and c) or, if step d) comprises irradiating the precursor composite material with e-beam or X-ray or gamma radiation (e.g. from a cobalt 60 source) of sufficient intensity to cure all layers of the composition, it may be conducted after some or all repetitions of steps b) and c).

In an eighth aspect of the invention there is provided a process for preparing a sheet of material from a trunk of a banana tree comprising:
a) separating a sheet of wet material from the trunk, and
b) drying said sheet of wet material at a temperature or temperatures between about 30 and about 150° C.
   Step a) may comprise cutting the sheet of wet material from the trunk, or may comprise peeling the sheet of wet material circumferentially from the trunk. The sheet of wet material may have a water content in one of the following ranges: from 20 to 97%, from 50 to 97% and from 85 to 95%. The process may additionally comprise the step of passing the sheet of wet material between two rollers under pressure in order to remove water therefrom, said step being conducted before the step of drying the sheet.

In a ninth aspect of the invention there is provided a method for stabilising a veneer, for example a veneer of less than about 0.5 mm thickness, said process comprising:
applying a radiation-curable water-compatible composition to a surface of the veneer, said composition comprising at least one radiation-polymerisable species selected from the group consisting of monomers and oligomers and mixtures of monomers and oligomers, whereby the composition wets the surface of the veneer;
irradiating the composition on the veneer to cure the composition on the veneer to produce a coated veneer; and
optionally, drying the coated veneer under conditions such that the veneer does not warp.

The composition may be a radiation-curable water-compatible composition which is radiation curable without the necessity to reduce the water content of the composition prior to curing. The composition may have a solids content of at least about 55% w/w, w/v or v/v. The composition may have a solids content of at least about 60% w/w, w/v or v/v. The veneer may have a thickness of between 0.5 mm and 0.1 mm. The veneer may have a thickness of between 0.5 mm and 0.2 mm. The veneer may be a timber veneer, for example. The veneer may be banana paper, for example. The composition may include a stain. The stain may be water compatible. The stain may be a water based stain. The stain may be an alcohol based stain. The stain may be a wood stain. The composition may be as described above, optionally with one or more of the optional features described earlier. The drying may be sufficiently slow as to avoid warping of the veneer. The drying may be at a temperature between about 40 and about 90° C. It may be conducted under an increasing temperature gradient from about 40° C. to about 90° C.

### BRIEF DESCRIPTION OF THE DRAWINGS

Preferred embodiment of the present invention will now be described, by way of an example only, with reference to the accompanying drawings wherein:

FIG. 1 is a diagram of a belt filter press;

FIG. 2 is a flow chart showing a process for forming a composite material according to the invention; and

FIG. 3 is a flow chart showing a process for forming a composite material after preserving a substrate.

### DETAILED DESCRIPTION OF THE INVENTION

In the present invention it is shown how the problems of the prior art can be overcome by the use of a new range of novel monomer and oligomer systems which may contain low percentages of water. More importantly these new systems (compositions) are water compatible, thus enabling processing of coatings, especially wash up on line, to be achieved with aqueous materials. The compositions may be radiation-curable water-compatible compositions which are radiation curable without the necessity to reduce the water content of the composition prior to curing. The systems may be water dispersible, water soluble, water emulsifiable, may form microemulsions in water, or may be water compatible in some other fashion. They may be high solids systems. They may have a solids content of at least about 60%, or at least about any of the following percentages: 65, 70, 75, 80, 85, 90 or 95%, or in one of the following ranges: about 55 to about 100%, about 60 to about 100%, about 70 to 100, 80 to 100, 90 to 100, 95 to 100, 55 to 98, 55 to 97, 55 to 96, 55 to 90, 55 to 90, 55 to 80, 55 to 70, 55 to 95, 55 to 80, 55 to 70, 55 to 65, 58 to 63, 60 to 98, 60 to 97, 60 to 96, 60 to 90, 60 to 90, 60 to 80, 60 to 70, 60 to 95, 70 to 98, 70 to 97, 70 to 96, 70 to 90, 70 to 95, 70 to 90, 70 to 80, 75 to 95, 75 to 98, 75 to 97, 75 to 96, 75 to 90, 75 to 93, 75 to 90, 75 to 80, 75 to 87, 75 to 85%, 80 to 98, 80 to 97, 80 to 96, 80 to 90, 80 to 95, 80 to 93, 80 to 85, or 80 to 87, 85 to 97, 85 to 95, 85 to 90, 90 to 97, or 90 to 95, e.g. one of the following percentages about 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94 95, 96, 97, 98, 99 or 100% on a weight or volume basis. In this specification and claims, the term “solids” refers to substances that are not carriers, solvents etc. (other than carriers or solvents that have other functions, e.g. as polymerisable or copolymerisable species). “Solids” includes monomers, oligomers and other additives and/or active substances (e.g. photoinitiators, defoamers etc. if present), and it should be recognised that some of these substances are not solid at room temperature. The solids in the composition may be dissolved in a solvent. The solids in the composition may be in liquid form. As used herein, the term “water compatible” means any one of the following: water dispersible, water soluble, water emulsifiable, or capable of forming a microemulsions in water.

The resin systems of the present invention may comprise a carrier. The carrier should be water compatible, e.g. water soluble. It may be aqueous, e.g. water, or a solution of one or more solutes (organic solvents, salts, water soluble monomers and/or oligomers etc.) in water. Alternatively the carrier may comprise an organic solvent that is water compatible. It may be an alcohol (e.g. methanol, ethanol, propanol, isopropanol, ethylene glycol, polyethylene glycol) or some other solvent (e.g. acetone, DMSO, NMP, propylene carbonate etc.) or mixture of solvents, or a combination of a water compatible organic solvent with water.

Formulations developed from this invention are applicable to the coating of a wide variety of substrates, especially celluloses such as paper and timber. These formulations are referred to herein as resin compositions, or alternatively as resin systems. Commonly when the resin compositions of the invention are applied to the substrates, they penetrate at least part way into the substrate or into a surface layer thereof. They may penetrate to one of the following depth ranges: between about 1 micron and 1 cm into the substrate, 1 micron to 1 mm, 1 to 100 microns, 1 to 10 microns, 10 microns to 1 cm, 100 microns to 1 cm, 1 mm to 1 cm or 10 microns to 1 mm, e.g. to about one of the following depths: 1, 2, 5, 10, 20, 50, 100, 200 or 500 microns, or about 1, 2, 3, 4, 5, 6, 7, 8, 9 or 10 mm or more than 10 mm. They may penetrate throughout the substrate. Where the substrate is a veneer they may penetrate part way through the veneer. Where the substrate is a paper (e.g. banana paper) they may penetrate part way through the paper. Where the substrate is a veneer they may penetrate throughout the veneer. Where the substrate is a paper (e.g. banana paper) they may penetrate throughout the paper. On curing, the resin composition may chemically bond to the substrate, for example to cellulose in the substrate, to form a composite material which has the cured resin chemically bonded on the surface thereof and commonly also at least partially therein. In the paper area is the inventor has developed a new type of product which is structurally different to conventional papers, since the new product is not pulped and therefore contains significant amounts of lignin, which influences its subsequent properties. The lignin content of the substrate may be up to about 40% lignin (on a dry weight basis), or up to about one of the following: 35, 30, 25, 20, 15, 10 or 5% lignin, or in one of the following ranges: about 0 to 40, 5 to 40, 10 to 40, 20 to 40, 30 to 40, 0 to 30, 0 to 20, 0 to 10, 0 to 5, 5 to 30, 5 to 20, 5 to 10, 10 to 30 or 20 to 30% lignin, e.g. about one of the following percentages: 0, 1, 2, 3, 4, 5, 6, 7, 8, 9, 10, 11, 12, 13, 14, 15, 16, 17, 18, 19, 20, 25, 30, 35 or 40% (on a dry weight basis). Thus the present invention may be applied to substrates from which the lignin has not been extracted. The substrate may be a fibre-containing substrate (e.g. a fibre-containing sheet), such as a paper. It may be a papyrus, a banana paper, a hemp-derived paper, a paper or some other type of fibre-containing substrate, or may be a non-fibre-containing substrate. A new product may be obtained from the banana tree by a modified process similar to that used to obtain timber veneers, as described herein. As used herein, the term “veneer” refers to a thin sheet of material (commonly less than about 5 mm thick) of wood, paper or other similar material. Because of the lack of pulping this banana paper (b.p.) possesses a distinct economic advantage when compared to other celluloses which are pulped, as the pulping process is expensive and environmentally unfriendly since large volumes of water are utilised in the process. The b.p. is also naturally flame retarded because of the presence of the lignin and is physically strong when compared to conventional pulped papers. A disadvantage of this b.p. is that it is off white, and even brown, in colour and also possesses no gloss. The process described in the present invention can be applied to the b.p. to give value added properties. These properties may for example include clear and pigmented gloss, semi-gloss and matt finishes. Such products can possess strong moisture resistance, scuff resistance and the like, these properties being ideal for many applications especially in the graphic arts field. The coating described here for b.p. can also be applied to any other paper to achieve a value added property. The examples of the invention cited here are exemplary and should not be taken as being comprehensive.

The substrates of the present invention may be coated with the resin composition on one side only, or on both sides, and may optionally have resin composition at least partially cured within one or both surfaces and/or in the bulk of the substrate.

The substrate used in the present invention may be a non-wet (or dry) substrate. The substrate used in the present invention may be a wet substrate. In this context, “wet” may be taken to refer to a water content above the equilibrium water content at room temperature and 65% relative humidity (RH). For reference purposes it may be noted that normal paper has an equilibrium water content at room temperature and 65% RH of about 15%, whereas the banana paper described herein has an equilibrium water content at room temperature and 65% RH of about 7-8%. The lower water content of the banana paper may be attributed to its high lignin content. The wet substrate may have a water content that is at least about 50% higher than the equilibrium content at room temperature and 65% RH, or at least one of the following about 100, 150, 200, 250, 300, 350, 400, 450, 500, 600, 700, 800, 900 or 1000% higher than the equilibrium content at room temperature and 65% RH (provided that the water content is no higher than about 97% by weight of the substrate), or it may have an water content that is in one of the following ranges: about 50 to 1000, 100 to 1000, 200 to 1000, 500 to 1000, 50 to 500, 50 to 200, 100 to 800, 100 to 500 or 500 to 800% higher than the equilibrium content at room temperature and 65% RH, e.g. one of the following water contents: about 50, 100, 150, 200, 250, 300, 350, 400, 450, 500, 600, 700, 800, 900 or 1000% higher than the equilibrium content at room temperature and 65% RH. The dry substrate may have a water content at room temperature and 65% RH that is less than that defined as “dry”, e.g. between about 0% water and a concentration defined above as “dry”. It may have a water content at room temperature and 65% RH that is less than the equilibrium content at room temperature and 65% RH, or between that equilibrium concentration and about 0% water content.

The current invention is also particularly relevant to the coating of timber, especially the current expanding market for prefinished boards where exceptional scuff resistance is required. The processes of the current invention can also be used for coating other substrates, e.g. laminated boards such as laminated MDF (medium density fibreboard) and the like, sheets of material derived from the trunk of a banana plant, medium density fibreboard, particle board, timber veneer, paper, polystyrene foam, fibre cement board, other cement board, board made from compressed wheat, Masonite™, board made from reconstituted wood fibre, animal hide etc. The timber veneer may be derived from any desired timber, including hardwood or softwood timber, e.g. eucalypt, teak, cedar, pine, oak, mahogany, maple, fir, poplar, beech, ash, cherry or walnut. In particular, the present invention is suited for coating either high water content or low water content substrates. Thus, unlike many prior art coating systems, the present invention may be applied to a substrate having a high water content, e.g. having a water content of at least about 20% by weight. In this context a percentage by weight is taken to be a percentage by weight of the total. Thus for example a substrate having 20% by weight water would have a dry weight of 80% and 20% water. A suitable substrate (or the surface 1, 2, 3, 4, 5, 6, 7, 8, 9 or 10 microns thereof) may have at least about 20%, or one of the following water contents: at least about 25, 30, 35, 40, 45, 50, 55, 60, 65, 70, 75, 80, 85 or 90% water, or a water content in one of the following ranges: between about 20 and 97, 30 and 97, 40 and 97, 50 and 97, 60 and 97, 70 and 97, 80 and 97, 90 and 97, 90 and 95, 70 and 95, 50 and 95, 50 and 90, 70 and 90, 80 and 90, 20 and 70, 20 and 50, 20 and 40, 20 and 30, 20 and 50, 30 and 50, 40 and 50, 30 and 60 or 30 and 50%, e.g. one of the following water contents: about 20, 25, 30, 35, 40, 45, 50, 55, 60, 65, 70, 75, 80, 85, 90, 91, 92, 93, 94, 95, 96 or 97% water by weight. The resin systems of the present invention may also be applied to low water content substrates, for example having less than about 20% water by weight (or wherein the surface 1, 2, 3, 4, 5, 6, 7, 8, 9 or 10 microns thereof has less than about 20% water by weight), or a water content of one of the following: less than about 15, 10, 5, 2 or 1%, or in one of the following ranges: between about 0 and 20, 0 and 15, 0 and 10, 0 and 5, 0 and 2, 5 and 20, 10 and 20 or 1 and 5%, e.g. one of the following water contents: about 0, 0.5, 1, 1.5, 2, 3, 4, 5, 6, 7, 8, 9, 10, 11, 12, 13, 14, 15, 16, 17, 18, 19 or 20% water by weight. Low water content substrates that are usable preferably are such that the resin system has a low contact angle, or a zero contact angle, with the substrate, so that the resin system can spread evenly on the surface of the substrate.

Specifically with respect to the b.p. paper, a new product can be made using conventional UV technology involving oligomer acrylates blended with multifunctional acrylate monomers. This technique produces coated materials, however these specific coatings cannot be reduced with water and need solvents for this purpose. This limits their flexibility in use when compared to the water compatible resins previously described. The technique can however produce very tough products.

### Types of Resins Systems Used

The types of resins used in the present invention include epoxies, urethanes, polyesters, aldehyde derivatives and materials based on donor (D) and acceptor (A) charge-transfer (CT) complexes. These resins may comprise polymerisable unsaturated groups, such as acrylate, methacrylate, acrylamide or acrylamide groups, or mixtures thereof. Not only can these new resins be used individually for specific coating applications, they can also be integrated as hybrids and/or blends with each other and also optionally, with conventional radiation curable epoxy acrylates, urethane acrylates (both aromatic and aliphatic) and polyester acrylate systems.

More conveniently the resin system can be compounded using hydrophilic monomers, oligomers and resin materials now existing in the market place and very well known to those versed in the industry. These materials can be blended and diluted with water and/or other aqueous diluents to facilitate application viscosity then having the ability to cure when irradiated by external sources of energy in many applications. The coatings can be formulated to dry, crosslink or cure without prior removal of diluent water simply by the exposure to a conventional form of radiation.

These latter coatings involve recently developed novel resin systems which are water compatible. These include aldehyde acrylate technology, modified polyester aldehyde acrylate systems, thiol processes involving both —ene and acrylate components, water compatible urethanes also water compatible epoxy acrylates as described in Australian Patent 762311: “Radiation curable resin composition”. These include salts of an epoxy-amine adduct and an unsaturated acid. Suitable epoxy compounds for making these include a condensation product of epichlorohydrin and bisphenol A. Other resins include amino resins. These may be reaction products of formaldehyde with urea or melamine. In examples, urea, formaldehyde and an amine (e.g. ethylene diamine, 1,3-diaminopropane, hydroxyethylamine, uron etc.) may be prepared. Other examples include glyoxal resins, made from urea or melamine (or a mixture of these) with formaldehyde, glyoxal and an alcohol. Glyoxal can be reacted with hydroxyl acrylates to give UV curable resins when 4% of a photoinitiator like Irgacure 184 is used. Thus in an example, glyoxal (1.0 mole) is reacted with hydroxypropyl acrylate (HPA, 3.5 moles) and pentaerythritol tetraacrylate (PETA, 0.5 mole) to give a resin which cures under UV using conditions similar to the previous examples. The ratio of reactants can be varied with those listed being preferred.

As a modification to the above process, unsaturated polyester can be added to the reaction. Any amount may be added with up to about 50% by weight preferred. Other amounts are selected from the following ranges: up to about 45%, up to about 40%, up to about 35%, up to about 30%, up to about 25%, up to about 20%, up to about 15%, up to about 10%, about 5 to 50, about 10 to 50, about 20 to 50, about 5 to 40, about 5 to 30, about 5 to 20, about 10 to 30 or about 20 to 50, e.g. one of the following amounts: about 5, 10, 15, 20, 25, 30, 35, 40, 45, 50%. Polyesters similar to the Orica product which has a phthalic anhydride to maleic anhydride ratio of 3/2 are preferred.

The systems may include a Michael adduct of an amine with a polyfunctional acrylate or methacrylate, or with an acrylate prepolymer. The amine is commonly a secondary amine. Suitable unsaturated acids for use in making the salts include acrylic acid, methacrylic acid (optionally substituted on the methyl group), fumaric acid, sorbic acid, citraconic acid, maleic acid and mixtures of any two or more of these.

Other resin systems that may be used in the present invention a donor/acceptor component capable of forming a charge transfer complex, either together with a Lewis acid or in the absence of a Lewis acid. The donor/acceptor component should be a bifunctional compound having an electron donor group and an electron withdrawing group and a polymerisable unsaturated group, or a mixture of (a) at least one unsaturated compound having an electron donor group and a polymerisable unsaturated moiety; and (b) at least one unsaturated compound having an electron acceptor group and a polymerisable unsaturated group. Prior to curing, the resins used in the present invention may have a mean molecular weight (weight average or number average) of between about 500 and about 20000. The molecular weight may be between in one of the following ranges: about 500 to 10000, about 500 to 5000, about 500 to 2000, about 1000 to 20000, about 5000 to 20000, about 10000 to 20000, about 1000 to 10000, about 1000 to 5000 or about 5000 to 10000, e.g. one of the following values: about 500, is 600, 700, 800, 900, 1000, 1500, 2000, 2500, 3000, 3500, 4000, 4500, 5000, 6000, 7000, 8000, 9000, 10000, 12000, 14000, 16000, 18000 or 20000, or may be greater than 20000.

The resin systems described above may also comprise polymerisable monomers and/or resins that are not water compatible. These may be incorporated into a water compatible resin system in sufficiently low proportion that the resin system remains water compatible. The proportion will depend on the nature of the water compatible resins, the solids content and the nature of the monomer and/or resin that is not water compatible. Typical proportions of non water compatible resins/monomers to total resin in a water compatible resin according to the present invention may be less than about 20% by weight, or may be in one of the following ranges: less than about 15, 10 or 5%, about 0 to 20, about 5 to 20, about 10 to 20, about 0 to 15, about 0 to 10, about 0 to 5 or about 5 to 10%, e.g. one of the following values: about 0, 1, 2, 3, 4, 5, 10, 15 or 20%, although other proportions may be appropriate in some circumstances.

Radiation that may be used to cure the resin systems includes UV radiation, gamma radiation, e-beam radiation and X-ray radiation, or, in some circumstances, gamma radiation. Commonly the resin is formed as a film on the substrate and then irradiated. The film may be between about 1 and about 1000 microns thick, or have a thickness in one of the following ranges: about 1 to 500, about 1 to 200, about 1 to 100, about 1 to 50, about 1 to 20, about 1 to 10, about 10 to 1000, about 50 to 1000, about 100 to 1000, about 500 to 1000, about 10 to 500, about 10 to 100, about 10 to 50, about 50 to 500 or about 50 to 100 microns, e.g. may have one of the following thicknesses: about 1, 2, 3, 4, 5, 6, 7, 8, 9, 10, 15, 20, 25, 30, 35, 40, 45, 50, 60, 70, 80, 90, 100, 150, 200, 250, 300, 350, 400, 450, 500, 600, 700, 800, 900 or 1000 microns thick. The film may be between about 1 and about 1000 gsm (i.e. g/m²). It may be one of the following: about 1 to 500, about 1 to 200, about 1 to 100, about 1 to 50, about 1 to 20, about 1 to 10, about 10 to 1000, about 4 to 60, about 4 to 50, about 50 to 1000, about 100 to 1000, about 500 to 1000, about 10 to 500, about 10 to 100, about 10 to 50, about 50 to 500 or about 50 to 100 gsm, e.g. one of the following: about 1, 2, 3, 4, 5, 6, 7, 8, 9, 10, 15, 20, 25, 30, 35, 40, 45, 50, 60, 70, 80, 90, 100, 150, 200, 250, 300, 350, 400, 450, 500, 600, 700, 800, 900 or 1000 gsm. Commonly UV cured films will be between about 10 and about 100 gsm, and e-beam or x-ray cured films will be between about 2 and 10 gsm.

In order to obtain a thin film of the resin system on a substrate, it is convenient for the contact angle of the uncured resin system on the substrate to be low, for example less than about 200, or less than one of the following: about 15, 10, 5, 2 or 1°, or in one of the following ranges: about 0 to 20, about 0 to 15, about 0 to 10, about 0 to 5, about 0 to 2 or about 0 to 1°, e.g. about one of the following values 0, 0.5, 1, 1.5, 2, 2.5, 3, 3.5, 4, 4.5, 5, 6, 7, 8, 9, 10, 15 or 20°. The uncured resin system preferably can spread on the substrate.

In order to spread readily on a substrate, the resin composition should also have a suitably low viscosity. The viscosity may be sufficiently low that the resin system can spread evenly on the substrate within about 10 seconds, or within one of the following times: about 9, 8, 7, 6, 5, 4, 3, 2 or 1 second. The viscosity may be less than about 5000cP, or less than about one of the following: 400, 300, 200, 100, 500, 200, 100, 90, 80, 70, 60, 50, 40, 30, 20 or 10cP, or in one of the following ranges: about 1 to 5000, about 1 to 2000, about 1 to 1000 about 1 to 500, about 1 to 200, about 1 to 100, about 1 to 90, about 1 to 80, about 1 to 70, about 1 to 60, about 1 to 50, about 1 to 40, about 1 to 30, about 1 to 20 or 1, about 1 to 10, about 10 to 5000, about 100 to 5000, about 500 to 5000 about 1000 to 5000, about 2000 to 5000, about 10 to 1000, about 100 to 1000, about 500 to 1000, about 10 to 500, about 10 to 200, about 10 to 100, about 10 to 50, about 10 to 20, about 50 to 500 or about 50 to 200cP, e.g. about one of the following viscosities: 1, 2, 3, 4, 5, 6, 7, 8, 9, 10, 15, 20, 25, 30, 35, 40, 45, 50, 60, 70, 80, 90, 100, 150, 200, 250, 300, 350, 400, 450, 500, 600, 700, 800, 900, 1000, 1500, 2000, 2500, 3000, 3500, 4000, 4500 or 5000cP. In order to achieve the desired thickness, the film may be allowed to spread spontaneously, or the desired thickness may be achieved by passing the substrate with the uncured resin system thereon past a doctor blade at a suitable distance from the substrate. The resin composition may also be applied to the substrate by roller coating, spraying, curtain coating, vacuum coating or some other suitable method.

The radiation used to cure the resin system should be at a wavelength and energy sufficient to cure the resin system. The wavelength may be a wavelength that is at least partially absorbed by the resin system. The radiation used to cure the resin system may be e-beam or X-ray. The e-beam or X-ray may have an energy of less than about 2.5MRad, or in one of the following ranges: less than about 2.4, 2.3, 2.2, 2.1, 2, 1.9, 1.8, 1.7, 1.6, 1.5, 1.4, 1.3, 1.2, 1.1 or 1 MRad, about 1 to about 2.5MRad, about 1.5 to 2.5, about 2 to 2.5, about 1 to 2, about 1 to 1.5 or about 1.5 to 2MRad, e.g. one of the following energies: about 1, 1.1, 1.2, 1.3, 1.4, 1.5, 1.6, 1.7, 1.8, 1.9, 2, 2.1, 2.2, 2.3, 2.4 or 2.5MRad. Alternatively or additionally the radiation may be UV radiation or a combination (sequential and/or simultaneous) of any two or more of UV, e-beam, gamma ray and X-ray radiation. If a combination of e-beam and X-ray is used, each individually, or both in combination, may have the energy defined above. In some embodiments of the invention, the resin systems contain no photoinitiator (i.e. no photoinitiator is separately added when forming the resin system). This may be an advantage, since the final film has no photoinitator residues. These residues can cause yellowing or may initiate degradation processes in the cured resin. Such systems may spontaneously photoinitiate when irradiated at the appropriate wavelength. In other embodiments, a photoinitiator is added to the resin system. This may be in a concentration of less than about 5% (w/w or w/v, relative to either total resin system or to resin solids), or in one of the following ranges: less than about 4, 3, 2, 1, 0.5 or 0.1%, about 0.1 to about 5, about 0.1 to 2, about 0.1 to 1, about 0.1 to 0.5, about 0.5 to 5, about 1 to 5, about 2 to 5 or about 0.5 to 2%, e.g. about one of the following concentrations: 0.1, 0.2, 0.3, 0.4, 0.5, 0.6, 0.7, 0.8, 0.9, 1, 1.5, 2, 2.5, 3, 3.5, 4, 4.5 or 5%. The systems may be cured using near UV (about 400 to about 200 nm wavelength, up to about 420 nm). (Wavelengths in the range 400 to 420 nm are considered to be in the near UV range, although they are also considered at times to be within the visible range.) The wavelength may be in one of the following ranges: about 200 to 420, about 200 to 400, about 200 to 350, about 200 to 300, about 200 to 250, about 250 to 400, about 300 to 400, about 350 to 400, about 250 to 300 or about 300 to 250 nm, e.g. about one of the following wavelengths: 200, 210, 220, 230, 240, 250, 260, 270, 280, 290, 300, 310, 320, 330, 340, 350, 360, 365, 370, 380, 390, 400, 405, 410, 415 or 420 nm. The UV beam may for example be provided by an LED source, e.g. a GaAs or InGaAs or InGaAl LED. These may be advantageous as they commonly provide radiation in a range that is relatively non-hazardous. The intensity of the UV beam may be sufficient to cure the resin system. The intensity may be for example between about 1 and about 500W/cm², or in one of the following ranges: about 10 to 500, about 20 to 500, about 50 to 500, about 100 to 500, about 200 to 500, about 1 to 200, about 1 to 100, about 1 to 50, about 1 to 20, about 1 to 10, about 1 to 5, about 50 to 300, about 50 to 200, about 50 to 100, about 100 to 500, about 200 to 500, about 300 to 500, about 100 to 300 or about 150 to 250 W/cm², e.g. about one of the following intensities: 1, 1.5, 2, 2.5, 3, 3.5, 4, 4.5, 5, 6, 7, 8, 9, 10, 15, 20, 25, 30, 35, 40, 45, 50, 60, 70, 80, 90, 100, 150, 200, 250, 300, 350, 400, 450 or 500 W/cm².

The resin compositions of the present invention are commonly cured on a substrate in a continuous manner. Thus the substrate will be continuously coated with the uncured (i.e. liquid) resin system, and the coated substrate will be then continuously passed under a suitable radiation source (UV, e-beam or X-ray, or a combination thereof, as appropriate). The intensity of the radiation and the rate at which the coated substrate is passed under the radiation source will be interdependent. Thus the higher the intensity of radiation, the faster the substrate may be passed. In this way, the appropriate dose of radiation may be delivered to the resin composition. If too little radiation is delivered, the resin may not cure completely, resulting in such features as a tacky surface, insufficient mechanical strength, extractable matter remaining in the partially cured film etc. If too much radiation is delivered, energy is wasted, and the film may suffer yellowing or other discolouration, and may suffer degradation which may affect its physical properties. Depending on the nature of the resin composition and the intensity of the radiation, a suitable rate at which the is coated substrate may be passed under the radiation source may be between about 1 and about 1000 m/min, or at one of the following rates: about 1 to 500, about 1 to 200, about 1 to 100, about 1 to 50, about 1 to 20, about 1 to 10, about 1 to 5, about 5 to 100, about 10 to 100, about 20 to 100, about 50 to 100, about 5 to 50, about 5 to 20, about 5 to 10, about 10 to 20, about 12 to 18, about 50 to 1000, about 100 to 1000, about 200 to 1000, about 500 to 1000, about 50 to 500, about 10 to 500 or about 10 to 200 m/min, e.g. about one of the following rates 1, 2, 3, 4, 5, 6, 7, 8, 9, 10, 11, 12, 13, 14, 15, 16, 17, 18, 19, 20, 25, 30, 35, 40, 45, 50, 555, 60, 65, 70, 75, 80, 85, 90, 95, 100, 110, 120, 130, 140, 150, 160, 170, 180, 190, 200, 250, 300, 350, 400, 450, 500, 600, 700, 800, 900 or 1000 m/min, or may be greater than 1000 m/min. The rate should be such that a sufficient dose of radiation is delivered to the uncured resin to cure it, but insufficient to overcure or degrade it, at the intensity and wavelength of radiation used. The exposure time of the composition to achieve cure may be in one of the following ranges: less than about 5 minutes, less than about 2 minutes, less than about 1 minute, less than about 30 seconds, less than about 20, 10, 5, 2 or 1 second, about 0.1 to about 60 seconds, about 0.1 to 30, about 0.1 to 10, about 0.1 to 5, about 0.1 to 1, about 0.1 to 0.5, about 0.5 to 60, about 0.5 to 10, about 0.5 to 2, about 1 to 60, about 1 to 30, about 1 to 10, about 1 to 5, about 10 to 60, about 20 to 60, about 30 to 60 or about 5 to 30 seconds, about 1 to 5 minutes, about 0.1 seconds to 5 minutes, about 30 seconds to 5 minutes, about 30 seconds to 2 minutes, e.g. about one of the following times: 0.1, 0.2, 0.3, 0.4, 0.5, 0.6, 0.7, 0.8, 0.9, 1, 1.5, 2, 2.5, 3, 3.5, 4, 4.5, 5, 6, 7, 8, 9, 10, 15, 20, 25, 30, 35, 40, 45, 50 or 55 seconds or about 1, 1.5, 2, 2.5, 3, 3.5, 4, 4.5 or 5 minutes. Under certain conditions, the exposure time may be less than 0.1 s, e.g. about 0.05 or 0.02s. It should be noted that the cure times above may be insufficient to produce cure of the entire composition. However they should be sufficient to form a cured surface, so that the substrate having the at least partially cured coating thereon (and possibly also therein) is handlable without damage to the surface. Full cure in depth may require considerable time. It may require up to about 5 days, or one of the following time ranges: up to about 4, 3, 2 or 1 day, about 1 hour to 5 days, about 12 hours to 5 days, about 1 to 5 days, about 2 to 5 days, about 1 hour to 2 days, about 1 hour to 1 day, about 1 to 12 hours, about 1 to 6 hours, about 12 hours to 2 days, or about 1 to 3 days, e.g. about one of the following times: 1, 2, 3, 4, 5, 6, 12 or 18 hours, or about 1, 1.5, 2, 2.5, 3, 3.5, 4, 4.5 or 5 days. The full in depth cure may proceed following further manipulation of the coated substrate without damage to the coating.

Following curing of the resin composition at least to the extent that the resulting composite material is handlable without damage to the cured resin coating thereon, it may be desirable to apply a top coating to the composite material. This may be for decorative or aesthetic purposes, on may be to protect the cured resin coating, e.g. from radiation (e.g. UV) damage. A is suitable protective coating is a clear acrylated urethane product from Bayer which is commonly used in automotive applications.

The cured resin coatings obtained by radiation curing of the resin compostions described herein commonly have excellent physical properties. These may include one or more of: high abrasion resistance, high scuff resistance, high hardness, high gloss, high flexibility, high water resistance (i.e. low water absorption) high transparency and high thermal stability (i.e. resistance to thermal degradation). In an example, treatment of a plasterboard with a resin composition as described above cut the water absorption of the plasterboard from about 60% to approximately 0%.

Examples of the water compatible resins capable for being used in this invention follow.

The first of the series are based on the Australia Patent 762311, the contents of which are incorporated herein by cross-reference. The principle of these radiation curable resin compositions involves use of a water soluble amine salt prepolymer formed between an oligomer having at least one amine group and an unsaturated carboxylic acid.

The following example demonstrates preparations of the above process in which a portion of the epoxy groups are pre-reacted with acrylic acid prior to addition of a secondary amine to form the epoxy amine adduct and subsequently formation of the amine/acrylic acid salt.

To 0.1 mole (36 g) of bisphenol A diglycidyl ether (Araldite 6010) is added varying amounts of acrylic acid together with 0.1 g hydroquinone monomethyl ether inhibitor and 0.5 g catalyst. The mixtures are reacted at 100° C. for 40 minutes and then cooled to 95° C., then diethanolamine 0.1 mole is added over several minutes, allowing the subsequent exotherm to proceed to 140-150° C. with no external heat. The product is allowed to cool to 90° C., and water is then added with rapid stirring producing a white stable dispersion. Acrylic acid is then added slowly with continuous stirring to solubilise the resin solution. After 15 minutes, the solution is allowed to cool, inhibitor added and transferred to a dark glass container. The sample is then coated at 5 microns thickness onto calendered paper and cured under a UV light of 200 watts/cm intensity at 15 m/minute in one pass. The above resin composition should contain a photoinitiator such as Irgacure 184. Concentrations of up to 4% by weight are preferred.

A further modification of the process involves the preparation of an epoxy amine resin which is reacted with an unsaturated acid to form a resin salt in accordance with the invention. One mole of bisphenol A diepoxide resin (above) was reacted with at least 1 mole of diethanolamine to form an adduct, allowing the exotherm of this reaction to take its course over 5-10 minutes. The composition was diluted with water or quenched into water to form a stable dispersion of the adduct. To this dispersion, 2 moles of acrylic acid or methacrylic acid were added to produce a cationic resin solution, with very similar properties of those resins formed from epoxy acrylate half ester described in the previous example. These resins have low odours and colour and will photopolymerise, when exposed to UV light, to a hard tack-free state.

The inventor has also, surprisingly, found that reaction of suitable water-soluble or water-dispersible oligomers with a phosphite or a phosphine can provide a product that is more readily curable. The product may be curable using UV radiation without use of added photoinitiators, or may be e-beam or X-ray curable at low intensity of e-beam or X-ray. The phosphite may be a triorganophosphite. The phosphine may be a triorganophosphine. The phosphite may be a triaryl phosphite such as triphenylphosphite. The phosphine may be a triarylphosphine such as triphenyl phosphine. Mixtures of phosphites and phosphines may be used. The inventor hypothesises that the phosphite or phosphine may form a charge transfer (CT) complex with the oligomer which is more readily polymerisable than the original oligomer, however the present invention should not be restricted to any such mechanism of operation. The ratio of phosphite or phosphine (or mixture thereof) in the oligomer may be between about 0.1 and about 15% w/w or w/v, or in one of the following ranges: about 0.1 to 10, about 0.1 to 5, about 0.1 to 2, about 0.1 to 1, about 1 to 15, about 5 to 15, about 10 to 15, about 1 to 10, about 2 to 10, about 5 to 10 or about 1 to 5%, e.g. about one of the following ratios: 0.1, 0.2, 0.3, 0.4, 0.5, 0.6, 0.7, 0.8, 0.9, 1, 1.5, 2, 2.5, 3, 3.5, 4, 4.5, 5, 6, 7, 8, 9, 10, 11, 12, 13, 14 or 15%. Thus reaction of the resin with the phosphine or phosphite may activate the resin to cure by UV and/or X-ray and e-beam.

Thus to the epoxy acrylate (10 g) (produced as described above from Bisphenol A diglycidyl ether and acrylic acid) was added triphenyl phosphite (1.0 g), and the mixture heated to dissolve the triphenyl phosphite and then cooled. The resin was then UV cured under a 200 W/inch UV mercury lamp at 15 m/min in one pass without use of a photoinitiator. In a control experiment, the above was repeated but without the addition of triphenyl phosphite. In this case 1% photoinitiator was required to cure the epoxy acrylate under the same conditions as described above. Triphenyl phosphite may be used in concentrations from 0.1% or more (w/v or w/w), commonly between about 1 and 10%. Numerous examples of this process have been performed with other oligomers and monomers as additives and the facile cure was observed with the phosphite treated resins. Triphenyl phosphine may also be used in a similar process, however it is somewhat less efficient than triphenyl phosphite.

Modifications to the above procedures can be used and are described in AU762311. In particular, the procedures can be modified to include melamine formaldehyde based resins as follows.

To 324 g of 37% formalin (4 moles) is added 126 g of melamine (1 mole) at room temperature and heated with stirring, to 70° C. and held until clear, about 40 minutes. The solution is cooled to 45° C. and 145 g of 40% glyoxal (1 mole) is added with constant stirring, and held for a further 30 minutes. A clear pale amber solution results, to which is added 144 g of acrylic acid (2 moles) and allowed to cool. The resultant solution is a very pale, clear and odour-free solution which when cast onto a metal or paper substrate and exposed to UV radiation, will cure rapidly to a hard, tack-free and odour-free clear film, with good water and solvent resistance when irradiated in the presence of a photoinitiator like Irgacure 184 at up to 4% by weight as preferred.

### Urethane Resins

A water compatible urethane can be made by reacting an aliphatic diisocyanate such as hexamethylene diisocyanate with an hydroxy acrylate like HPA above. Hydroxyethyl acrylate (HEA) can also be used in both processes. The resulting resins UV cure as above. Thus IPDI (isophorone diisocyanate) (222 g) heated to 60° C. with HPA (130 g) then cooled gives a UV curable resin.

### Maleic Anhydride-Hydroxy Acrylate Resins

Maleic anhydride reacted with hydroxy acrylates such as HPA and HEA with mole ratios of 1.0 to 1.0 or 1.0 to 2.0 (MA/HPA) give UV curable water compatible resins.

All of the water compatible resins discussed in this last section are applicable to UV coating papers, especially the banana paper. Particularly with the banana paper all of the coatings discussed in this application yield new, novel products with unique properties. If pigments are included in the coatings, the papers, particularly the banana paper can be painted and UV cured with these pigmented coatings, again yielding novel products.

### Charge Transfer (CT) Complexes

The CT complexes used in the present work involve interaction between donor (D) and acceptor (A) functional groups and are obtained from at least one unsaturated compound that has an electron donor group and an unsaturated compound containing an electron withdrawing group. The unsaturated compound includes a polymerisable unsaturated moiety bonded to the electron donor group and another a polymerisable unsaturated moiety bonded to the electron withdrawing group. The bonds are typically covalent bonds.

Objectives of the present invention can be achieved by employing one unsaturated compound that contains both the electron donor group and the electron withdrawing group. Preferably the charge transfer complex is obtained from at least one unsaturated compound that has an electron donor group and at least another unsaturated compound that has an electron withdrawing group.

The compounds employed to provide the charge transfer complex can be ethylenically unsaturated. They may be acetylenically unsaturated. When the complex is formed from two or more compounds, typically, the double bond molecular ratio of the electron donating compound to the electron withdrawing compound is about 0.5 to about 2, and or about 0.8 to 1.2 or about 1.1. It may be in one of the following ranges: about 0.5 to 1, about 1 to 2, about 0.6 to 1.8, about 0.7 to 1.6, about 0.8 to 1.4 or about 0.9 to 1.1, for example about one of the following ratios: 0.5, 0.6, 0.7, 0.8, 0.9, 1, 1.1, 1.2, 1.3, 1.4, 1.5, 1.6, 1.7, 1.8, 1.9 or 2. The complexes employed for the present invention are stable under normal conditions.

In particular the compositions do not spontaneously polymerise. The strengths or both the donor and acceptor groups are not to the high level that could result in spontaneous polymerisation. Instead they polymerise under the influence of the necessary ultraviolet light or ionising radiation.

The complex should, on initial exposure to UV, generate radicals which can initiate free radical polymerisation. In addition to UV, the polymerisation can also be achieved by the use of ionising radiation such as gamma rays or electrons from an electron beam machine or X-rays. This process can be achieved to workable radiation doses and in air.

Typical donor and acceptor monomers are listed in Table 1. This list is by no means comprehensive but demonstrates the wide potential of the technique using the different monomers. It should be noted that in Table 1 it is not necessary to use the electron acceptor in the same row as a particular electron donor with that donor.

The functional groups that are particularly active as acceptors are maleic diesters, maleic amide half esters, maleic diamides, maleimides, maleic acid half esters, maleic acid half amides, fumaric acid diesters and monesters, fumaric diamides, fumaric acid monoesters, fumaric acid monoamides, exomethylene derivatives, itaconic acid derivatives, nitrile derivatives of preceding base resins and the corresponding nitrile and imide derivatives of the previous base resins particularly maleic acid and fumaric acid. Mixtures of any two or more of these may be used.

TABLE 1
Typical Donor and Acceptor Monomers

| Donors | Acceptors |
|---|---|
| Alkyl vinyl ethers | Acrylonitrile |
| Alkyl vinyl sulfides | Citraconic anhydride |
| Alkylphenyl vinyl ethers | β-Cyanoacrolein |
| Benzoselenophene | Diethyl fumarate |
| Butadiene | Diethyl maleate |
| Cyclopentene | Divinylsulfone |
| 1,1-Diphenylethylene | Fumaronitrile |
| Dimethylbutadiene | N,N′-Fumaroyldiphyrrolidone |
| Furan | Maleic anhydride |
| Indole | Maleimide |
| Indene | Methyl acrylate |
| Isoprene | Methyl glutaronitrile |
| α-Methylstyrene | Methyl maleate |
| Methyl methacrylate | Picryl methacrylate |
| 2-Naphthyl methacrylate | N-Phenylmaleimide |
| Phenylacetylene | Sulfur dioxide |
| Phenyl vinyl ethers | Tetracyanoquinodimethane |
| 2-Isoprophenylnaphthalene | Tricyanoethylene |
| Stilbene | Vinylidene cyanide |
| Styrene | N-methyl maleimide |
| Thiophene | N-ethyl maleimide |
| N-Vinylcarbazole | dimethyl maleate |
| Vinyl acetate | dimethyl fumarate |
| Vinyl chloride | adamantane fumarate |
| 1-Vinylindole | fumaric dinitrile |
| Vinylnaphthalene | |
| Vinylpyridine | |
| N-Vinylpyrrolidone | |

Polyfunctional, that is polyunsaturated compounds including with two, three, four and even more unsaturated groups can like wise be employed, and in fact are preferred.

Examples include polyethylenically unsaturated polyesters, for example, polyesters from fumaric acid and maleic acid or anhydrides thereof.

The functional groups that are particularly active as donors are vinyl ethers, alkenyl ethers, substituted cyclopentanes, substituted cyclohexanes, substituted furans or thiophenes, substituted pyrans and thiopyrans, ring substituted styrenes, substituted alkenyl benzenes, substituted alkenyl cyclopentanes and cyclohexenes. Mixtures of any two or more of these may also be used. In the styrene systems, substituents in the ortho- and para-positions are preferred. Suitable substituents include alkyl groups and alkoxy groups. These groups may have between about 1 and 6 carbon atoms (e.g. 1-3, 4-6, 2-6 or 3-6 carbon atoms), or may have more than 6 carbon atoms. They may have 1, 2, 3, 4, 5 or 6 or more than 6 carbon atoms. They substituents may be straight chain (e.g. methyl, ethyl, 1-propyl), branched chain (e.g. 2-propyl, 2-butyl, isobutyl, tert-butyl) or cyclic (e.g. cyclohexyl, cyclobutyl, cyclopentylmethyl), provided that the branched or cyclic substituents have at least 3 carbon atoms. They may be unsaturated (e.g. ethenyl, ethynyl) provided that they have at least 2 carbon atoms. Each of the above substituents may optionally be itself substituted, e.g. by a halide, an alkoxy group (as defined above) or other suitable substituent. A preferred donor acceptor system includes optionally substituted styrene in combination with optionally substituted maleic anhydride and/or optionally substituted maleimide.

In addition, polyfunctional, that is, polyunsaturated compounds including those with two, three, four or even more unsaturated group can likewise be employed.

With respect to the ethers, monovinyl ethers and divinyl ethers are especially preferred. Examples of monovinyl ethers include alkylvinyl ethers, typically having a chain length of 1 to 22 carbon atoms. Divinyl ethers include divinyl ethers of polyols having for example 2 to 6 hydroxyl groups including ethylene glycol, propylene glycol, butylene glycol, 3-methylpropane triol and pentaerythritol.

Some more active specific monomers containing the donor group are monobutyl-4-propenylbutoxy carbonate, monophenyl-4-vinylbutoxy, ethyl diethylene glycol, p-methoxy styrene, 3,4 dimethoxy propenyl benzene, N-propenyl carbazole, monobutyl 4 propenylbutoxy carbonate, monopheny-4-propenyl butoxy carbonate, isoeugenol and 4-propenylanisole.

Bifunctional compounds containing both acceptor groups and a donor group can be used. Examples of suitable bifunctional compounds include those made from condensing maleic anhydride with 4-hydroxybutyl vinyl ether and the like.

A further optional aspect of the invention is the use of unsaturated polyesters as a component, optionally a predominant component, in these formulations. The best of the polyesters is defined later in the specification and is an Orica product.

In the present invention such polymers, like Orica polyester when dissolved in monomers, even styrene, have been shown to cure very slowly with UV and are not currently commercially attractive. When the CT complexes are added to the polyester as additives, the resulting resin mixture cures well especially with excimer sources.

Under certain circumstances with conventional UV systems, photoinitiators (PI) may be needed, however many UV sources can achieve cure without PI. Without these CT additives the polyester system is unsuitable for UV commercial curing. This separate aspect of the invention thus involves the use of the CT complexes already discussed as additives to accelerate the cure. If UV radiation is replaced by ionising radiation as a source of radiation, then PI may also be used. In this case, PI may or may not be necessary to achieve cure in an acceptable time at commercially acceptable throughput rates.

### Photoinitiators

If needed, certain types of photoinitiators can be used to achieve faster cure. Examples of photoinitiators include benzoin ethers such as α,α-dimethoxy-2-phenylacetophenone (DMPA); α, α-diethoxy acetophenone; α-hydroxy-α,α-dialkyl acetophenones such as α-hydroxy-α, α-dimethylacetophenone and 1-benzoylcyclohexanol; acyl phosphine oxides such as 2, 4, 6-trimethylbenzolyl diphenyl phosphine oxide and bis-(2,6-dimethoxybenzoyl)-2,4,5-trimethylphenylphosphine; cyclic benzils; intermolecular hydrogen abstraction photoinitiators such as benzophenone, Michlers ketone, thioxanthones, benzil and quinones; and 3 ketocoumarins. Typical of such photoinitiators are the Ciba Geigy range of Irgacure 819, 1800, 1700, 184 and the like, also Darocure 1173 and others such as Irgacure 2959 and the like.

Hybrid Systems—e.g. Acrylates

A further development of the invention is the use of combinations of the previously discussed resins with each other and also with conventional acrylates. In some examples, the conventional acrylates themselves are useful such as primers for coating the banana paper. A typical system here is the thiol-acrylate process where inclusion of 20% of trithiol like trimethylol tris(3-mercaptopropionate) accelerates the UV curing of a multi-functional acrylate like hexanediol diacrylate. This effect may be achieved using between about 10 and about 50% of the trithiol, or one of the following concentrations: about 10 to 40, about 10 to 30, about 10 to 20, about 20 to 50, about 30 to 50 or about 20 to 30% by weight, e.g. about one of the following concentrations: 10, 15, 20, 25, 30, 35, 40, 45 or 50%. It is preferable to use as little trithiol as possible consistent with achieving the desired acceleration, as the trithiol is an expensive component. The inventor has found that use of thiols may improve adhesion of the resin composition to a substrate. The required level of thiol may be at least about 1%, or at least about one of the following concentrations 1.5, 2, 2.5, 3, 3.5, 4, 4.5, 5, 6, 7, 8, 9 or 10% in order to achieve improved adhesion. This may be required for substrates that are difficult to bond to, such as melamine laminates and Masonite.

### Additives

Conventional additives can be used with the above resin systems to achieve specific properties. Thus one or more of pigments, fillers, wetting systems, flow and slip aids and defoaming agents as are well known to those versed in the industry may be used as required. Stabilisers or polymerisation inhibitors may also be used in order to stabilise the uncured resin and improve its shelf life. The shelf life may be extended using a stabiliser to up to 6 months or more. Suitable stabilisers include Genorad 16 (from Rahn). Suitable stabilisers may be thermal polymerisation inhibitors. Thus the composition used in the method of the invention may include a thermal polymerisation inhibitor such as di-t-butyl-p-cresol, hydroquinone, benzoquinone or a derivative thereof, an acrylate material or other suitable polymerisation inhibitor.

The composition may contain an ultraviolet light stabiliser which may be a UV absorber or a hindered amine light stabiliser (HALS). Examples of UV absorbers include benzotriaziols and hydroxybenzophenones. The most preferred UV stabilisers are the HALS such as bis-(1,2,2,6-pentamethyl-4-piperidyl)sebacate which is available from Ciba as Tinuvin 292 and bis(2,2,6,6-tetramethyl-4-piperidinyl)sebacate available from Ciba under the brand name Tinuvin 770.

For those substrates that require flame retarding, the following additives may be used. Banana paper itself is naturally flame retarded, however if any of the coatings used need flame retarding the following additives may be needed in smaller amount. Preferred examples of such additives may be selected from the following:
a. “FYROL 76”* and/or (with or without free radical catalyst such as tertiary butyl hydroperoxide, cumene peroxide or ammonium persulphate);
b. “FYROL 51”*
c. “FYROL 6”* and/or “FYROL 66”* with or without catalyst;
   Products Of Akzo Chemicals Ltd;
d. “PE-100” and “W-2” (Eastern Colour Chemicals P/L) of the USA;
e. “PROBAN”* with or without catalyst such as ammonia or an amine;
   an Albright and Wilson Aust. Pty Ltd. Product);
f. “PYROVATEV”* with or without catalyst;
   a Ciba Geigy Aust. Pty Ltd Product;
g. “PYROSET”* “TOP” and “TKOW” with or without catalyst;
   Products of Cyanamid Aust. Pty Ltd;
h. simple phosphates such as mono, di, and triammonium orthophosphates and their alkali metal equivalents;
i. alkali metal an ammonium sulphamates;
j. alkali metal and ammonium polyphosphates;
k. ammonium sulphates;
l. alkali metal and ammonium chromates and dichromates;
m. alkali metal carbonates;
n. alkali metal tungstate;
o. boric acid and borax;
p. organophosphorus or organoboron compounds and mixtures of two or more of the above.

The preferred amount for each system may be determined by experiment. When the additives are used with the resin the finished product may be fire retarded in accordance with Australian Standard AS1530 Parts 2 and 3.

The use of new UV resin techniques in coating of paper from the banana tree are described above. These coatings are now shown to lead to the preparation of new products, as outlined below, by the novel processes used.
1. UV Coating of Dry Paper

The paper produced from the banana tree by a veneer process is described elsewhere herein. A process for producing sheets of fibres from banana plants for making paper has been described in WO2006/029469. Because it is not pulped, the paper from the banana tree contains significant percentages of lignin thus giving the paper unique properties. After veneering, water may be removed from the paper leaving a dry product. This may be achieved in part by compressing the product between rollers. The pressure between the rollers should be sufficient to squeeze the desired amount of water from the veneer. Further drying may be achieved by heating and/or passing a stream of air or other suitable gas past the product. This product can now be UV coated and cured with resin systems described above. The resin system may be in the form of a radiation-curable water-compatible composition which is radiation curable without the necessity to reduce the water content of the composition prior to curing. Alternatively, the sheet may be coated either before removal of water or after removal of only part of the water therein (e.g. after compression between rollers), or may be coated with no removal of water. UV adhesives and inks can also be applied in the same manner. This coating-and-curing process can be performed on-line or in a separate step off-line. The coatings can be clear or contain pigments such as titanium dioxide, also yellow, red, blue and black pigments and the like as known in the paint and ink industries. The coatings on this dry paper can give pliable products of varying degrees of stiffness, from very soft to very hard. Thus the coatings described herein may provide improved physical properties for the papers. Such papers can be used in the graphic arts industry, packaging, is building bags and office supplies. Specific examples of these materials (the list is not meant to be complete) are printing paper, manila folders, wallpaper and the like. The unique advantages of this UV process for achieving these materials are summarised below:

### Advantages of UV Curing in Banana Paper Applications and Timber Veneer Applications

a) The systems may be solvent free.
b) The systems dry quickly (more rapidly than conventional systems) at room temperature.
c) There are significant energy savings in these systems.
d) The systems require very much smaller plant space.
e) The drying equipment can be readily retrofitted into an existing BPP (banana ply paper) line making it amendable to in-line processing, however off-line can also be used if required.
f) Labour costs are lower since the systems are amendable to automation.
g) Low heat is generated in the BPP when the coating dries.
h) There is virtually no pollution from the line to the atmosphere during drying.
i) Flexibility in coating formulation is easily achieved. Thus clear and pigmented coatings can be applied. These may be matt, semi-gloss, and high gloss, in which last case the gloss is much higher than is capable of being achieved in conventional solvent based processes.
j) BPP sheets can be printed using this technology.
k) Wet on wet coatings can be dried. Thus for example a base white coat could be applied followed by a printed design and the whole system dried in a fraction of a second in one step.
l) Wastage on the lines is low.
m) The process leads to unique applications, not readily achievable by conventional solvent-based processes.
n) The coatings can be flame retarded.
o) The coatings can also contain small percentages of water, leading to improved adhesion to BPP, since such water can swell the upper layer on the BPP allowing surface penetration of the coating.
p) The coatings are water compatible, thus wash-up in the plant after processing can be with water and not solvent and so is environmentally friendly.
q) It is not necessary to evaporate water from the resin systems prior to UV curing.
r) Water compatible pigments (e.g. in the form of a water compatible stain) can be included is in the resin systems thereby avoiding a separate staining step.

The level of pigments needed for inks and coatings are conventional and are discussed in US6,767933, the contents of which are incorporated herein by crossreference. They are typically as follows:

| | Inks | | Paints | |
|---|---|---|---|---|
| | | % | | % |
| | Pigment Level | Photo- | Pigment Level | Photo- |
| Colour | to Cover % | initiator | to Cover % | initiator |
| Black | 20 | 10 | 4 | 4 |
| Blue | 15 | 10 | 9 | 4 |
| Red | 18 | 10 | 10 | 4 |
| Yellow | 12 | 10 | 9 | 4 |
| White | 50 | 4 | 10 | 4 |

The above are not meant to be comprehensive but typical. More details are provided in the original patents.

### 2. UV Coating of Wet Paper

A unique application of the UV coating process is that the paper can be coated and cured whilst wet with water and, after drying off the water, the coating remains uniform with good adhesion to the paper. This same process can be applied to UV adhesives and inks. Conventional solvents and water-based coatings also with adhesives cannot be used in this way, as they coalesce and do not form uniform films. The advantages of this wet-coating process are that the paper cannot only be coated on line, if necessary, but also under conditions where all the original water does not have to be removed for successful coating to be achieved. Thus, at 30% water which is the level usually reached after preliminary crushing from the initial 90-95% water, direct UV coating of the resins, paints or inks can be applied and the paper passed under a UV lamp, for example a 240 W/inch high pressure mercury at 30 metres/min (any practical speed can be used) and the coating cured whilst the paper remains wet. This wet paper can subsequently be dried by conventional methods such as with thermal ovens, microwave and the like, or with heated lines or the wet paper can simply be allowed to dry at room temperature. This current UV coating process has the added advantage that it helps to lower the percentage of water in the paper and thus accelerates drying. The important feature of the process is that good bonding between coating and paper is achieved when the paper is finally dry. The process also can be lead to a shortening of the processing line for drying and coating the paper.

In an example, wet banana paper (about 95-97% by weight water) was obtained from Papyrus Australia. This company obtained the sample by peeling off a veneer from a wet banana tree trunk and then crushing the excess water from the veneer to a level of about 30%. At this stage the veneer was coated with a resin composition having 60% epoxy acrylate and 1% Darocure 1173 in water (61 wt % solids). The epoxy acrylate used was made from Bisphenol A diglycidyl ether and acrylic acid as described previously herein. The composition also contained (i) conventional black stain or (ii) conventional red stain (in two separate runs). Then the coated veneer was passed under a 200 W/inch mercury UV lamp at 15 m/min. The coating cured on the substrate, which remained wet. The resulting composite was dried in air at ambient temperature. A separate sample, obtained in the same fashion as described above, was dried using a similar process as used for drying wood veneers. Thus the wet composite was passed through an oven with a temperature gradient from about 40 to 90° C. A third sample, also obtained in the same fashion as described above, was exposed to hot air from a blower with a temperature program increasing from 50 to 100° C. All of the resulting paper veneers were stable and showed no warping.

3. Lamination of Paper with and without UV Curing

There are two types of laminations used in this work:

(i) lamination of dry paper to the substrate; and

(ii) lamination of paper whilst still wet.

Each process (i) and (ii) can involve UV curing of a coating or ink either prior to lamination or after lamination. Substrates typically that can be used for this lamination process (typical but not complete) include plasterboard (already papered or banana paper used to replace conventional plasterboard paper), fibrous cement board, polystyrene either foamed or not foamed, cardboard, strawboard such as the Ortec Boards termed Esiboard, any timber board with timber per se or processed timber such as MDF, particle board, plywood or masonite, PVC or other polymers like polyolefins, polycarbonate, PMMA and others used as cladding. The substrate may be used wet or dry, although they are normally used dry. Any substrates may be used for this process, polymers being particularly useful. Cardboard as substrate could be used in cheap housing especially for walls, also flooring, wall covers especially for wet areas and interior walls. These paper laminates can also be used in both interior and exterior applications. In the former case, lamination can be achieved using any conventional laminating adhesive, however the water-based EVAs (ethylene-vinyl alcohol adhesives) such as are used by Monocure in Australia are preferred. After coating the back of the paper with adhesive, the paper is attached to the substrate and dried, accelerated by heat if needed. For exterior purposes, special water-based exterior adhesives such as Nuplex Viking 1680 are suitable. These may also be used for internal applications as well. Weatherometer tests on these laminates using exterior quality adhesives have shown them to be successful in exterior exposure. It is possible to print onto either the wet or dry substrates having the resin coating thereon, using UV printing techniques. It is also possible to print onto the dry susbtrate having the resin thereon using convention printing techniques. This enables decoration or other designs, wording etc. to be applied.

Thus in a representative process, a wet veneer (paper, banana paper, timber etc.) is coated with a resin composition according to the present invention and cured as described elsewhere. An adhesive is applied to the substrate, and the coated wet veneer is applied to the adhesive. The resultant laminate is then dried in the oven, both curing the adhesive if necessary and drying the veneer. It will be clear that this process can also be used with a dried veneer. In this case it may not be necessary to dry in the oven if the adhesive is curable at room temperature.

### 4. Impregnation

A further application of the technology is in the formation of composite materials by impregnation of the banana paper with resin compositions according to the present invention. The substrates used here can be either paper from the newer process or core trunk material directly from the banana tree itself. For this purpose the core or paper is immersed in the resin solution and allowed to stand at room temperature until the core or paper is completely saturated with the resin composition. The impregnation process can be accelerated by performing the operation under at least partial vacuum. The vacuum may have an absolute pressure of between about 0.01 and about 0.5 bar, or in one of the following ranges: about 0.01 to 0.1, about 0.01 to 0.05, about 0.1 to 0.5, about 0.2 to 0.5, about 0.05 to 0.2 or about 0.1 to 0.2 bar, e.g. an absolute value of about one of the following: 0.01, 0.02, 0.03, 0.04, 0.05, 0.06, 0.07, 0.08, 0.09, 0.1, 0.15, 0.2, 0.25, 0.3, 0.35, 0.4, 0.45 or 0.5 bar. After immersion is complete, the resin-saturated product is cured either by oven treatment (usually at about 50-60° C.) or exposure to radiation sources such as cobalt 60 to doses usually of the order of 2 megarads. For oven cure systems, the resin composition preferably comprises a crosslinker, such as an acrylic crosslinking agent. The composition may also comprise a thermal initiator such as a peroxide (e.g. dicumyl peroxide, cumyl hydroperoxide etc.), an azo initiator (e.g. AIBN) or similar. The temperature for thermal cure will depend on the nature and composition of the resin composition. It may depend on the nature of the thermal initiator (if present). The finished core material can then be either hard or soft depending on the required end use which will be usually as a solid composite. The impregnated core can also be veneered to give a composite, like modified paper. Typical resins used in the process are outlined elsewhere herein and are commonly epoxy, urethane or polyester acrylates or combinations thereof. The water-compatible resins are to be preferred, especially the epoxy acrylate resins, since water is advantageous in the immersion process i.e. usually 25% (or in one of the following ranges: about 10 to 50, about 10 to 40, about 10 to 30, about 20 to 50, about 20 to 50, about 20 to 30 or about 30 to 40%, e.g. about one of the following: 10, 15, 20, 25, 30, 35, 40, 45 or 50% on a w/w or w/v basis) epoxy acrylate in water is preferred for immersion. The resins used are also UV curable (greater than 60 wt % solids in the water-compatible composition) and if photoinitiator is incorporated in the solution (approx. 1-2 wt % preferred) the product after immersion can be UV cured (surface cure) before finally curing the bulk resin incorporated by oven or cobalt-60 methods. To accelerate the thermal cure conventional catalysts can be used such as peroxides. In this process the resin is left impregnated in the trunk and thus differs from the following process in item (5) below.

### 5. Preservation & Bleaching

A problem with the banana tree harvesting is that at times production is such that there is an excess of trunks available for the veneering process. Thus, for example, in the cyclone season, trees are blown down and be on the ground until collected. Because of the large numbers suddenly available, processing by the veneering technique is restricted. It is now possible by the present process to preserve the tree trunk in original state for extended periods, possibly indefinitely. Thus, it is surprisingly found that the immersion process using the appropriate chemicals can lead to preservation of the trunk. A vacuum or partial vacuum may be applied in order to facilitate impregnation of the trunk by the resin composition described herein, e.g. containing an epoxyacrylate resin. In this system, as distinct from that described in the previous section 4, the trunk is immersed in the resin composition, as described elsewhere herein, but excess resin is pumped out, or the trunk is removed from the bulk resin composition (and optionally drained) leaving the trunk saturated but not impregnated with resin. This latter step may be conducted after extended storage of the trunk, or may be conducted before such storage. Immersion of the trunk in the resin composition may allow storage of the trunk without rotting or without other degradation, for periods of at least about 1 month, or in one of the following time ranges: at least about 2, 3, 4, 5, 6, 7, 8, 9, 10, 11 or 12 months, or at least about 1, 2 or 3 years, or about 1 month to 5 years, about 1 month to 3 years, about 1 month to 1 year, about 1 to 6 months, about 1 to 3 months, about 3 months to 5 years, about 6 months to 5 years, about 1 to 5 years, about 2 to 5 years, about 3 months to 1 year or about 3 to 6 months, e.g. for one of the following periods: about 1, 2, 3, 4, 5, 6, 7, 8, 9, 10, 11 or 12 months, or about 1, 2, 3, 4 or 5 years. Such resin compositions have an additional value: if they are the UV and/or gamma ray and/or e-beam and/or X-ray curable materials described earlier and contain photoinitiator, then the wet trunk after immersion can be subject to the veneer process to produce paper impregnated with resin that can be cured using UV, e-beam radiation and/or X-ray (as appropriate) on line as it is produced. Oven treatments can also be used if needed and thermal catalysts included in the resin solution prior to immersion. This current process preserves the tree from degradation and decay, also mould formation and thus the trunks from the immersion process can be processed at any subsequent time. The UV curable resins, particularly the water-based epoxy acrylates, are very efficient in this preservation process which is applicable to any water compatible or dispersible oligomer or immersion system. The resin composition used preserving as described above may be more dilute than that used for forming a cured layer on a substrate. Thus the preserving composition may have a solids concentration of as low as about 20%, or one of the following solids concentrations: about 25, 30, 35, 40, 45, 50, 60, 70, 80 or 90%. If the preserving composition has a solids concentration of less than about 50%, it may be necessary to add further, high solids (e.g. 70 to 95%) resin composition after formation of a veneer from the preserved trunk prior to curing in order to form a cured layer on (and optionally in) the veneer.

It was also observed that immersion of the banana trunk in the resin compositions of the present invention leads to bleaching of the trunk, leading to an attractive appearance of a veneer produced from that trunk. The bleaching is commonly complete after about 1-5 days immersion at room temperature, e.g. about 1, 2, 3, 4 or 5 days. Thus a banana trunk preserved for a period of months or more in such a preparation may be also bleached in the process.

6. Liquids from Banana Tree

The banana tree trunk contains liquids up to 90-95%, predominantly water. This liquid also contains a range of chemicals of interest commercially. Thus it is found that the paper itself has a unique property of being a natural release paper like the commercial release papers which are very difficult to make. The inventor believes that the release characteristics may come from silica derivatives embedded or copolymerised with the liquid or carbohydrate component of the paper. The liquids are found to contain a wide variety of chemicals from carbohydrates, sugars or silicon derivatives. Collection of these liquids and subsequent treatment by column chromatography and the like process could form the basis of a new chemical industry.

### 7. Adhesive for Development of Multiply Paper

The inventor has found that two or more banana ply papers may be fused together using the tannin type materials naturally incorporated in the paper to act as their own adhesive. Unfortunately, this process is not very efficient and partial delamination can occur i.e. the ply papers can separate partially, leading to detrimental effect on physical properties. It is observed that even with single-ply materials, evidence of the presence of two ply from the primary veneering process is seen, i.e. the tops of the papers show two veneers, thus suggesting that in the veneer process, in some cases, a single veneer is not removed during the cutting process i.e. the process is not fine enough.

The above problems can be overcome with the application of adhesives, water bases being preferred. There are two types of adhesives needed similar to those described before:

(i) for internal applications; and

(ii) for exterior use.

The internal applications include gluing ply to ply and also within ply samples where some delamination occurs indicating that during veneering the “supposed” single ply material which is cut off the stem is actually two very thin plys. The adhesive for this purpose is the EVA produced by Monocure and can be dried in air at room temperature or in an oven. For exterior purposes, the Nuplex Viking 1680 is recommended. This is a water-based material which again dries in air or can be oven cured. Suitable curing temperatures are between about 20 and 100° C., or one of the following temperature ranges: about 20 to 80, about 20 to 60, about 20 to 40, about 40 to 100, about 60 to 100, about 40 to 80 or about 30 to 50° C., e.g. about one of the following temperatures 20, 30, 40, 50, 60, 70, 80, 90 or 100° C.

Multiple sheets of material may be laminated together using the water-compatible resin compositions of the present invention (which may be thermally-curable and/or radiation-curable). Thus a sheet of paper, banana paper or similar material may be coated with a may be radiation-curable water-compatible resin composition as described herein. Another similar sheet may be similarly coated and the two laminated (i.e. layed face to face). The process may be repeated to form a multi-stacked uncured laminate having between about 2 and about 50 sheets (e.g. one of the following ranges: about 2 to 30, about 2 to 20, about 2 to 10, about 2 to 5, about 5 to 50, about 10 to 50, about 20 to 50, about 5 to 30 or about 5 to 10, e.g. about one of the following numbers of sheets: 2, 3, 4, 5, 6, 7, 8, 9, 10, 15, 20, 235, 30, 35, 40, 45 or 50), each having resin composition coated thereon (greater than 60 wt % solids in the composition and optionally having 1-2 wt % photoinitiator). The surface layer of resin composition may be cured using UV radiation (or optionally e-beam or X-ray as appropriate), and the remainder of the resin composition(s) in the laminate may subsequently be cured thermally or with gamma rays or with X-rays. For this process, it is necessary that the resin composition on the uppermost sheet be UV (or X-ray or e-beam) curable, although it need not necessarily be thermally curable. The resin compositions on the other sheets may also be UV (or X-ray or e-beam) curable, but should be thermally curable. To this end, the resin compositions on the other sheets should contain a thermal initiator such as a peroxide, hydroperoxide or azo initiator or a mixture of any two or more of these. They may also contain monomeric acrylic crosslinkers such as EGDMA trimethylol propane trimethacrylate etc. Thus the resin composition on the uppermost sheet may be the same as or different to the resin composition(s) on the other sheets. The process described above may result in a thin strong laminated veneer made from for example paper or banana paper.

8. Water Removal from Veneers

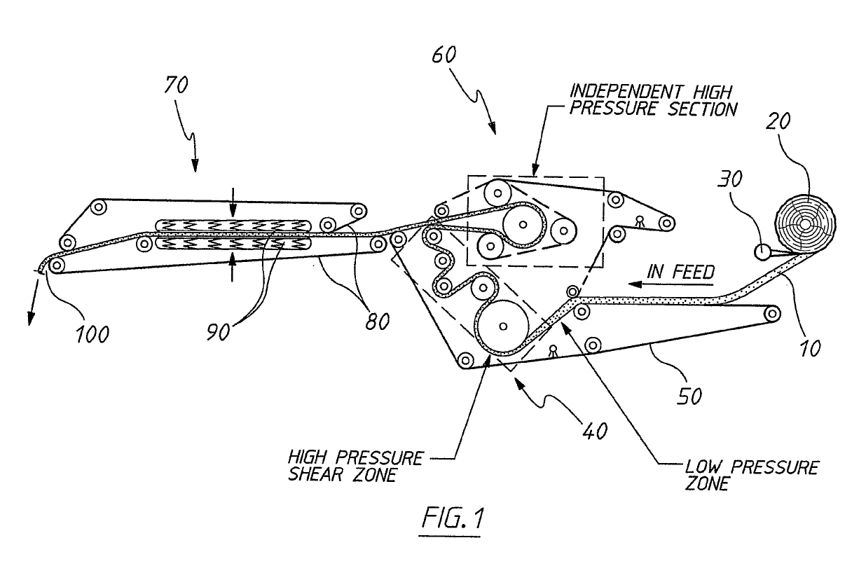

After crushing of veneers initially, water level is reduced from about 90-95% to about 30%. The final step of reducing to about 2% is difficult on line to keep up reasonable speeds. The final step may reduce the water level to between about 1 and about 15% (or to one of the following ranges: about 1 to 10, about 1 to 5, about 1 to 2, about 2 to 15, about 5 to 15, about 10 to 15, about 2 to 10, about 2 to 5 or about 5 to 10%, e.g. to one of the following levels: 1, 2, 3, 4, 5, 6, 7, 8, 9, 10, 11, 12, 13, 14 or 15%). A hot press plate facility as shown in FIG. 1 would satisfy this requirement. Thus FIG. 1 illustrates a system for peeling a fibrous sheet from the trunk of a banana plant and drying the sheet on line. In FIG. 1, a high water content fibrous sheet is peeled circumferentially from banana trunk 20 by means of blade 30, which is suitably located and angled. Sheet 10 passes initially into high pressure shear zone 40. It is initially supported by belt 50 in its wet and relatively weak state. In passing under pressure around the rollers in zone 40, water is removed from sheet 10. Sheet 10 then passes to independent high pressure section 60, where further water is removed. Finally sheet 10 passes to heated pressure zone 70. In zone 70, sheet 10 passes between silicone rubber belts 80, and belts 80 having sheet 10 between them pass between hot press plates 90. Hot press plates 90 are heated to a suitable temperature, commonly between about 50 and 100° C., and exert a suitable pressure on sheet 10, thereby removing further water from sheet 10, which finally exits the system at exit point 100. Sheet 10 may enter the system either directly from production from a banana log or may come on line directly from the crushing section where water content is reduced to 30%. At exit point 100, water content of sheet 10 is about 2%. The whole process depicted in FIG. 1 should take about 4 minutes.

The process used for drying will depend on various factors including the type of veneer (i.e. the type of timber) and the time available for drying. Crushing followed by heating is commonly more rapid than heating alone, but requires extra equipment to be installed. Heating may be sequential, with different temperatures at different stages of the process. Thus for example the veneer may pass through several heating zones at progressively higher temperatures. These may vary from about 30 to about 150° C. There may be one heating zone, or may be 2, 3, 4, 5, 6, 7, 8, 9 or 10 heating zones (or between about 1 and 10, 1 and 5, 2 and 10, 5 and 10 or 3 and 8 heating zones), or may be more than 10 heating zones. Alternatively (or additionally) there may be a drying zone with a temperature gradient that increases continually towards the outlet end thereof. It is important not to dry the veneers too rapidly as this may lead to warping. Thus at each stage of the drying process it is preferable that the veneer is at close to equilibrium with ambient moisture. Thus initially, when the water content of the veneer is highest, the temperature should be relatively low (e.g. about 40° C.) in order to avoid rapid water loss which would result in warping. As the water content in the veneer reduces, the temperature is increased progressively to maintain a relatively constant and low rate of moisture loss. In conventional timber veneering processes, it is difficult to dry a veneer of less than about 0.6 mm without warping, as it is difficult to achieve sufficiently low water loss. A composite material according to the present invention, having a cured resin composition on and optionally also in a veneer, may be prepared using thinner timber veneers, as the cured resin composition reduces the tendency of the veneer to warp. This increases the amount of veneer that may be produced from a given amount of timber.

9. Composites Especially with Waste Products

In Section 3, lamination processes were described where the substrate to which banana ply paper was being fixed was essentially a rigid board. It is now found that the strength of single ply banana paper may need to be increased and this can be achieved by forming a sandwich-laminated product involving three sheets of material, the outer two being banana paper and the inner a waste product like newspaper. All these are laminated together using the adhesives previously described. The laminated product has significantly higher strength and improved physical properties for certain applications. Instead of newspaper, plastic films such as polyolefins (especially wastes), other plastic films, even metals such as aluminium (thin for flexibility or thick for rigidity) can be used. In one example, pulp from a banana plant may be combined with paper waste and fabricated into a sheet which may be used in the present invention. It will be readily appreciated that the lamination process may be used with varying numbers of layers, e.g. one of the following numbers: 2, 3, 4, 5, 6, 7, 8, 9 or 10 layers, or more than 10 layers. Each may, independently, be a banana ply sheet as described above, or may be waste product, or may be some other product, such as those mentioned above. It is also possible to metallise a paper or ply product which has been treated with a resin according to the present invention. Thus following resin treatment and curing, a metallic coating may be applied to the treated substrate using processes well known in the art.

Additionally, the laminated products of the present invention may be affixed to a solid substrate. Thus for example a sheet of banana paper may be treated so as to apply a flexible coating of cured resin, as described elsewhere in this specification. The coated paper may then be affixed to a solid substrate, e.g. a wall, a sheet of wood, a sheet of fibre board, a panel of cement, a is panel of polystyrene (e.g. polystyrene foam), a sheet of metal or some other suitable substrate. The affixing may comprise gluing or otherwise fastening or adhering (stapling, nailing, pinning, etc.). The affixing may be conducted before or after drying the banana paper, or may be conducted without drying the banana paper. If the coated paper is glued to the substrate, the gluing may use a conventional adhesive, or it may use a resin system according to the present invention. It will be readily appreciated that the banana paper may be substituted by other suitable materials, such as paper, cardboard, cloth, animal skin etc.

### 10. Coating of Ultrathin Veneers

A potential commercial application of coating the wet veneers is to stabilise the product for subsequent further processing, although the present invention may also be used for coating dry veneers. The wet veneers (i.e. taken from a tree without drying) may commonly have a water content of up to 80-90% by weight. Two large subsequent applications are in:

(i) plywood manufacture; and

(ii) veneers for coating timber for use in furniture, flooring and the like.

Particularly for furniture, the higher quality veneers are used. These are expensive and the size of the forests from where these products are obtained are relatively small. Typical are the range of veneers provided by Gunns Limited in Tasmania from a range of exotic timbers such as Huon pine etc. although the process can be applied to other timbers and to veneers from banana trunks. Normally veneers are cut wet at 0.6 mm thickness and then stabilised by reducing the moisture from up to about 90% down to about 10-15% in oven treatment. These veneers are difficult to manufacture because they warp during drying. Thus the present invention may be used on veneers that are less than about 0.6 mm thick. The veneers may be in one of the following ranges: less than about 0.5, 0.4, 0.3 or 0.2 mm thick, or about 0.1 to about 0.6 mm thick, about 0.1 to 0.5, about 0.1 to 0.4, about 0.1 to 0.3, about 0.1 to 0.2, about 0.2 to 0.5, about 0.2 to 0.4 or about 0.2 to 0.3 mm thick, e.g. about one of the following thicknesses: 0.1, 0.15, 0.2, 2.25, 0.3, 0.35, 0.4, 0.45, 0.5, 0.55 or 0.6 mm thick. The present invention may also be applied to substrated (e.g. veneers) that are about 0.6 mm thick or greater, e.g. between about 0.6 and about 1 mm thick (e.g. about 0.6, 0.7, 0.8, 0.9 or 1 mm thick). Veneers may be obtained from the timber by either peeling or slicing.

The present inventor has taken wet radiata pine veneer of 0.3 mm thickness, treated it with the UV process outlined herein (without drying the veneer and using a radiation curable, water compatible resin in an aqueous composition with greater than 60 wt % solids and including a UV initiator of approx. 1-2 wt %) and then returned it to the oven for drying in the normal way. On the conclusion of the treatment the veneer was stable and had not warped. Normally (i.e. without the treatment described above) at this thickness it is difficult to dry a timber veneer without warping unless it is supported on a substrate. Thin veneer of about 0.2 mm thickness from the banana tree has been treated similarly and yields a stable material after drying. It is thus possible by this process to produce thinner veneers than 0.6 mm currently made: even 0.2 mm thick veneers can be achieved. Such a process increases production, thus being very economic and also of great value environmentally, since the same tree will produce at least three times the quantity of veneer previously possible. It is also expected that even thinner veneers than 0.2 mm could be produced with the correct cutting, manipulation equipment and techniques applied in the plant. In some instances, the veneer is crushed prior to treatment with a resin composition as described herein. In this case, the final thickness after crushing may be as described above. A further development in this process is that timber stains and/or other additives may be incorporated in the resin before coating the veneer. This provides a finished veneer which is ready for furniture or other application without further staining. The inventor has used conventional red and brown stains to illustrate this process.

In an embodiment of the invention there is provided a process for forming a composite material whereby a substrate in the form of a veneer of less than about 0.5 mm thickness is exposed to a radiation-curable water-compatible composition comprising at least one radiation curable oligomer for sufficient time for the composition to penetrate throughout the veneer, wherein the composition has a solids content of between about 70 and about 95% w/w or w/v and the veneer has a water content of at least about 20% by weight, optionally about 70 to about 90% by weight. The composition optionally also comprises a stain for staining the veneer and may also comprise other additives. The veneer is then irradiated for sufficient time to cure a surface layer of the composition. The veneer is then dried under conditions under which the veneer does not warp. Sufficient time is allowed for the composition to completely cure, thereby forming the composite material.

In an example, the inventor received from Gunns three wet 0.3 mm pinus radiata veneers which were coated with a resin composition having 60% epoxy acrylate and 1% Darocure 1173 in water, and also containing a conventional stain material. The epoxy acrylate was made from Bisphenol A diglycidyl ether and acrylic acid as described previously herein. Then the coated veneer was passed under a 200 W/inch mercury UV lamp at 15 m/min. The coating cured on the substrate, which remained wet. The wet veneer was dried for 4 minutes under a 40-90° C. temperature gradient after which a stable veneer was obtained which was not warped. The stain remained cured into the veneer, which was then sanded lightly as happens commercially in a furniture process. After sanding a light coat of UV cure resin similar to the above was applied and is cured. An alternate solvent based clear resin was also applied and air dried to simulate what would happen in a furniture finishing process. This system obviates the need to restain the resin.

The application of the technique described above is directly applicable to plywood manufacture. In manufacture of plywood, veneers are cut and then glued together to produce the plywood. Again cutting of the veneers (timber) limits this technology. By using the above UV (or other radiation curing) process thin veneers can be cut and then glued to provide a thinner plywood (if needed) but with good physical characteristics (strength etc.).

A further development of the plywood process obviates the need for a final coat on the plywood. Many industrial applications coat plywood to improve its appearance and wash resistance for ceiling and wall portion applications, amongst other areas. This coating process is carried out off-line as a further separate step in plywood manufacture and is expensive. Using the current process, the top veneer for the plywood process can be coated whilst the veneer is still wet (or the process may be used dry), and this veneer may then be glued to the remained of the plywood as it is assembled to provide a pre-finished product immediately available as it comes off line. If desired, it is possible to prepare a finished plywood laminate and then apply a resin coating as described herein to the finished plywood laminate.

Overall, the above examples and applications involving UV processes are also applicable to electron beam (EB) or X-ray, except that no photoinitiator is needed in this latter cases. EB and X-ray applications are particularly useful for metallising the paper for industrial requirements.

The present invention provides the following:

1. All applications may be applied to or involved in window furnishings and sunscreen products, for example blinds and shutters. In these applications (and others) it may be useful to incorporate a UV stabiliser into the resin formulation, so that the final product comprises the UV stabiliser. This may serve to inhibit degradation following outdoor exposure of the product, and thereby may extend the lifetime of the product.
2. Lamination may be to any substrate to decorate and improve its function e.g. flame retardency, water proofing, stiffness or durability in products applied as window dressing or sun protection.
3. Use of paper or its by product to make roller blind/pleated blinds, sliding panels, wood blinds, shutters, woven wood, etc.

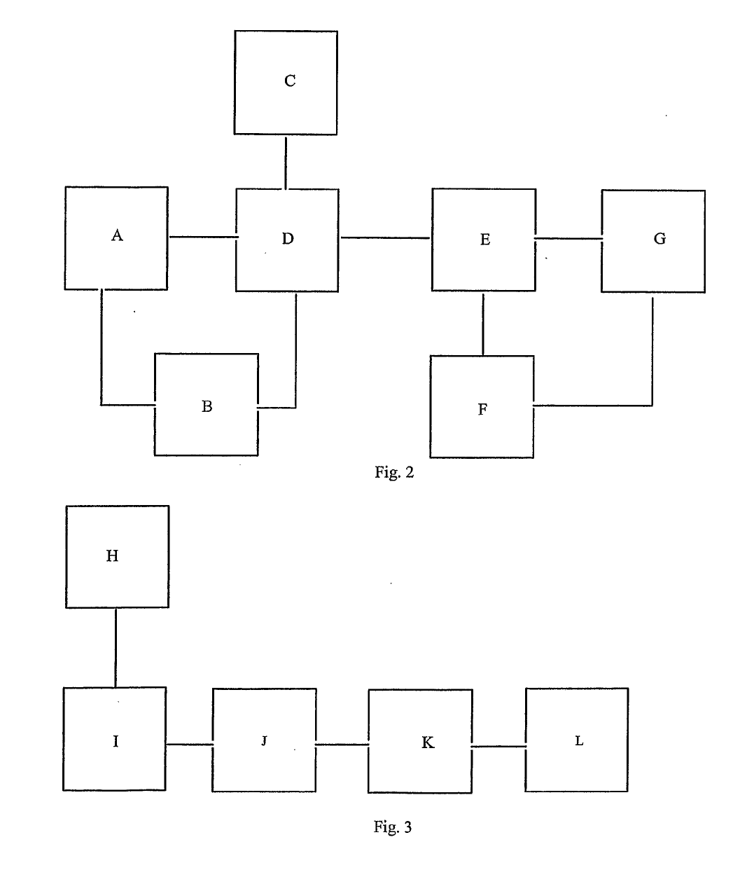

FIG. 2 illustrates a process for making a composite material according to the present invention. The flow chart of FIG. 2 contains the following steps:

A: formation of a veneer. This may be from a plank of wood, or from the trunk of a banana tree or some other substrate. It may involve peeling the veneer from the substrate or it may comprise is slicing the veneer from the substrate. Typically the veneer is less than about 0.5 mm thick, although the process is applicable to thicker veneers. The veneer may have up to about 95% by weight water, depending on its source.
B: crushing the veneer. This is commonly conducted by passing the veneer between two rollers under pressure, in order to squeeze some liquid from the veneer. The veneer may initially have a water content of up to about 97%, and after crushing this may be reduced to between about 30 and 60%.
C: formation of the resin composition. This may be achieved by combining the requisite reactive components (including radiation curable, water compatible resin and optionally a photoinitiator) with water in the desired concentrations. Commonly a solids content of the composition of about 70 to about 95% is used. The presence of water improves the compatibility of the resin composition with the veneer, which commonly contains substantial amounts of water. The resin composition may or may not contain a photoinitiator, depending in part on the type of radiation to be used in curing and in part on the resin components of the composition. The resin composition may optionally contain pigments in order to generate a pigmented product.
D: coating the veneer. The resin composition is spread on the veneer. It may be allowed to spread spontaneously, or the thickness of the film may be controlled by means of a doctor blade at a desired distance from the veneer. The thickness of the applied film is commonly between about 5 and about 100 microns, but may be outside that range.
E: curing the resin composition. This is achieved by means of UV, electron beam or X-ray radiation, depending on the nature of the resin composition. Commonly the coated veneer is passed under a source of the radiation at a speed of up to about 1000 m/min. This generates a composite material comprising the cured composition on the veneer.
F: gluing the composite material from step E to either other similar cured compositions or to a base substrate (a wall, a building panel or similar). This may be achieved using conventional gluing techniques or by using a radiation cured glue.
G: drying the cured composition. This is commonly achieved using an oven or a series of ovens. The ovens may be at progressively higher temperatures in order to progressively remove moisture from the cured composition. The ovens may be at temperatures from about 40° C., and up to about 150° C., and should be at temperatures that are not sufficient to cause the cured composition (or the cured resin which is comprised therein) to degrade or yellow. The drying process may be facilitated by passing dry air past the composite material, preferably at elevated temperature.

With reference to FIG. 2, a veneer is first formed according to step A. Step B (crushing) is optional, and may be omitted if required, since the resins compositions of the present invention are capable of spreading and curing on high water content substrates up to about 97% water. Equally, it will be apparent that a dry veneer (either obtained by drying a veneer obtained from step A or from some other source) may also be used to form a composite material as described herein. The radiation curable, water-compatible resin composition (having greater than 60 wt % solids), formed in step C, is applied to the veneer in step D such that the veneer is coated by the resin composition. The coated veneer then passes to step E, where the resin composition is cured using radiation. The resultant composite material, comprising the cured resin composition, may then be dried, as described in step G, or it may be glued or otherwise affixed to a substrate or another veneer. It may then be dried if required (as described in step G). Alternatively, the composite material may be used without drying.

FIG. 3 illustrates the process of preparing a composite material from a preserved substrate, as described herein. Steps of the process shown in FIG. 3 are:

H: formation of the resin composition. This is as described for C above.
I: soaking a substrate in the resin composition. This comprises at least partially immersing a substrate in the resin composition. The resin composition can act as a preservative to prevent rotting of substrates such as timber, banana trunks and other vegetable derived substrates. Thus commonly a log or a portion thereof (e.g. a timber log, a banana trunk log) will be immersed in the resin composition. The substrate may be stored in the resin composition for extended periods, e.g. 6 months to 1 year or more. This enables production of the ultimate product to be conducted continuously throughout a production cycle despite a seasonal, intermittent or discontinuous availability of the substrate.
J: forming a veneer from the substrate. In this step a thin veneer of the substrate is formed from the soaked substrate. The substrate is commonly removed from the bulk resin composition in which it was soaking, however some of the resin composition will be present in and on the substrate, so that the resulting veneer has the composition substantially evenly on a surface. The process of forming the veneer is similar to that described above for step A of FIG. 2.
K: curing. This is as described above for step E of FIG. 2.
L: drying. This is as described above for step L of FIG. 2.

With reference to FIG. 3, a process comprises formation of the resin composition (step H) and soaking the substrate in the resin composition (step I). When required the substrate is removed from the resin composition and allowed to drain, and a veneer is formed according to step J. The veneer will have the resin composition on the surface and possibly also at least partially infused into the surface and/or bulk thereof, and step K cures that resin composition on the surface (and possibly also in the surface and/or bulk of the veneer) in order to produce a composite material. If required this may be dried (step L) or may optionally be glued to a desired material as described in step F (FIG. 2) and then (if required) dried. A further option is that the production of a veneer from the substrate may be conducted prior to step I (soaking). Thus the veneer may be preserved in the resin composition after separation from the substrate rather than preserving the substrate and then forming a veneer from the preserved substrate. In this case, the preserved veneer would be removed from the resin composition and drained prior to curing.

1-95. (canceled)

96. A process for producing a composite material comprising:
applying a radiation-curable water-compatible composition to a surface of a substrate having a high water content, said composition comprising at least one radiation-polymerisable species selected from the group consisting of monomers and oligomers and mixtures of monomers and oligomers, whereby the composition wets the surface of the substrate, and wherein said composition comprises at least one radiation-polymerisable water-soluble oligomer or water-soluble monomer; and
irradiating the composition on the substrate to cure the composition and thereby produce the composite material, said composite material comprising the cured composition on the substrate.

97. The process of claim 96, wherein the composition is a UV-curable composition or an e-beam-curable composition or an X-ray curable composition and the step of irradiating comprises exposing the composition to UV radiation or e-beam radiation or X-ray radiation for sufficient time and at sufficient intensity to cure the composition.

98. The process of claim 96, wherein the composition does not contain a photoinitiator.

99. The process of claim 96, wherein the composition has a solids content of at least 70% w/w, w/v or v/v.

100. The process of claim 96, wherein the composition has a contact angle with the substrate of less than about 10°.

101. The process of claim 96, wherein the composition is aqueous.

102. A radiation-curable water-compatible composition comprising a reaction product of a radiation-curable water-compatible oligomer with a triorganophosphite or with a triorganophosphine, wherein the ratio of phosphite or phosphine in the oligomer is between about 1% and about 15% w/w or w/v.

103. The composition of claim 102, said composition being a UV-curable composition or an e-beam-curable composition or an X-ray-curable composition.

104. The composition of claim 102, which does not contain a photoinitiator.

105. The composition of claim 102, which has a solids content of at least 70% w/w, w/v or v/v.

106. The composition of claim 102, which has a contact angle with a substrate having a high water content of less than about 10°.

107. The composition of claim 102, which is aqueous.

108. The composition of claim 102, additionally comprising at least one radiation-polymerisable oligomer that is not water-compatible.

109. The composition of claim 102, wherein the triorganophosphite is triphenyl phosphite.

110. The composition of claim 102, wherein the radiation-curable water-compatible oligomer is an amine salt prepolymer.

111. A method for preserving a solid substance comprising immersing said substance in a radiation-curable water-compatible composition comprising at least one radiation-polymerizable species selected from the group consisting of monomers and oligomers and mixtures of monomers and oligomers, wherein said composition comprises at least one radiation-polymerizable water-soluble oligomer or water-soluble monomer.

112. The method of claim 111, wherein the substance has a water content of greater than or equal to about 20% by weight.

113. The method of claim 111, wherein the composition is a UV-curable composition or an e-beam-curable composition or an X-ray curable composition.

114. The method of claim 111, wherein the composition does not contain a photoinitiator.

115. The method of claim 111, wherein the composition has a solids content of at least 70% w/w, w/v or v/v.
